(19) United States
(12) Patent Application Publication
(10) Pub. No.: US 2026/0089805 A1
(43) Pub. Date: Mar. 26, 2026

(54) HEATER, AND HOT AIR BLOWER AND WATER PURIFIER HAVING SAME

(71) Applicant: Samsung Electronics Co., Ltd., Suwon-si (KR)

(72) Inventors: Woong HWANG, Suwon-si (KR); Minkyung LEE, Suwon-si (KR); Jeongnam CHEON, Suwon-si (KR)

(21) Appl. No.: 19/406,205

(22) Filed: Dec. 2, 2025

Related U.S. Application Data
(63) Continuation of application No. PCT/KR2024/008721, filed on Jun. 24, 2024.

(30) Foreign Application Priority Data
Aug. 23, 2023 (KR) 10-2023-0110897
Jan. 17, 2024 (KR) 10-2024-0007694

(51) Int. Cl. H05B 3/42; H05B 3/00; H05B 3/03

(52) U.S. Cl. CPC H05B 3/42; H05B 3/0019; H05B 3/03; H05B 2203/003; H05B 2203/021; H05B 2203/022

(57) ABSTRACT

A heater configured to heat a fluid is provided. The heater including a first graphene scroll configured to generate heat in response to a current flowing, a first electrode configured to apply a first voltage to the first graphene scroll, a second graphene scroll disposed in parallel to the first graphene scroll, forming a heating flow path, in which the fluid is heated, together with the first graphene scroll, and configured to generate heat in response to the current flowing, and a second electrode configured to apply a second voltage to the second graphene scroll.

### CROSS-REFERENCE TO RELATED APPLICATION(S)

This application is a continuation application, claiming priority under 35 U.S.C. § 365(c), of an International application No. PCT/KR2024/008721, filed on Jun. 24, 2024, which is based on and claims the benefit of a Korean patent application number 10-2023-0110897, filed on Aug. 23, 2023, in the Korean Intellectual Property Office, and of a Korean patent application number 10-2024-0007694, filed on Jan. 17, 2024, in the Korean Intellectual Property Office, the disclosure of each of which is incorporated by reference herein in its entirety.

### BACKGROUND

### 1. Field

The disclosure relates to a hot air blower and a water purifier including a heater.

### 2. Description of Related Art

A hot air blower is a device that provides hot air by drawing air, heating the drawn air, and then discharging the heated air. The hot air blower may include a fan and a fan motor for generating air flow, and a heat source for heating the drawn air. The fan, the fan motor, and the heat source may be disposed within a main body of the hot air blower, and when the fan rotates by the operation of the fan motor, air outside the hot air blower may be drawn into the main body, then heated by the heat source, and discharged again from the main body.

The types of the hot air blowers include hair dryers, which are mainly used at home, and industrial hot air blowers. Further, even when the hot air blower is not an independent device by itself, the hot air blower may be used as a module to heat air inside various devices such as home appliances.

A water purifier is a device that provides drinking water to users by removing harmful substances, which are contained in raw water such as tap water or groundwater, through various water purification methods such as sedimentation, filtration, and disinfection. The water purifier is configured to supply clean water to users by filtering incoming water through one or more water filters.

Based on the form of the water purifiers, the water purifiers may be classified into a direct type that is directly connected to a faucet, and a storage type that puts water in a container and passes the water through a filter. In addition, the water purifiers may be classified into natural filtration type, direct filtration type, ion exchange resin type, distillation type, and reverse osmosis type based on the purification principle or method.

Water that is purified by the water purifier may be discharged through a dispenser and may be used as drinking water or cooking water.

The water purifier may be configured to provide purified water at various temperatures. For example, the water purifier may provide cold water by including a cooler configured to cool the purified water. In addition, the water purifier may provide hot water by including a heater configured to heat purified water.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a heater including an improved structure to improve heating efficiency of fluid, and a hot air blower and a water purifier including the same.

Another aspect of the disclosure is to provide a heater including an improved structure to reduce power consumption, and a water purifier and a hot air blower including the same.

Another aspect of the disclosure is to provide a heater including an improved structure to improve a rate of temperature change, and a hot air blower and a water purifier including the same.

Another aspect of the disclosure is to provide a heater including an improved structure to allow a shape of a graphene scroll to be stably maintained, and a hot air blower and a water purifier including the same.

Another aspect of the disclosure is to provide a heater including an improved structure to facilitate heat generation control, and a hot air blower and a water purifier including the same.

Another aspect of the disclosure is to provide a heater including an improved structure to increase a flow rate, and a hot air blower and a water purifier including the same.

Additional aspects will be set forth in part in the description which follows and, in part, will be apparent from the description, or may be learned by practice of the presented embodiments.

In accordance with an aspect of the disclosure, a heater configured to heat a fluid, is provided. The heater includes a first graphene scroll configured to generate heat in response to a current flowing, a first electrode configured to apply a first voltage to the first graphene scroll, a second graphene scroll disposed in parallel to the first graphene scroll, forming a heating flow path, in which a fluid is heated, together with the first graphene scroll, and configured to generate heat in response to the current flowing, and a second electrode configured to apply a second voltage to the second graphene scroll.

In accordance with another aspect of the disclosure, a hot air blower is provided. The hot air blower includes a main body, a fan disposed in the main body, and a heater disposed in the main body and configured to heat air flowing along a heating flow path as the fan rotates. The heater includes a first graphene scroll configured to generate heat in response to a current flowing, a first electrode configured to apply a voltage to the first graphene scroll, a second graphene scroll disposed in parallel to the first graphene scroll, forming the heating flow path together with the first graphene scroll, and configured to generate heat in response to a current flowing, and a second electrode configured to apply a voltage to the second graphene scroll.

In accordance with another aspect of the disclosure, a water purifier is provided. The water purifier includes a dispenser configured to provide purified water, and a heater configured to heat the purified water flowing along a heating flow path. The heater includes a first graphene scroll configured to generate heat in response to a current flowing, a first electrode configured to apply a voltage to the first graphene scroll, a second graphene scroll disposed in parallel to the first graphene scroll, forming a heating flow path, in which a fluid is heated, together with the first graphene scroll, and configured to generate heat in response to a current flowing, and a second electrode configured to apply a voltage to the second graphene scroll.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view illustrating a hot air blower according to an embodiment of the disclosure;

FIG. 2 is a block diagram illustrating some components of the hot air blower according to an embodiment of the disclosure;

FIG. 3 is a view illustrating a heater included in the hot air blower according to an embodiment of the disclosure;

FIG. 4 is a cross-sectional view illustrating a graphene scroll of the heater included in the hot air blower according to an embodiment of the disclosure;

FIG. 5 is a view illustrating a graphene sheet forming the graphene scroll of FIG. 3 and electrodes connected to the graphene sheet according to an embodiment of the disclosure;

FIG. 6 is an enlarged view of a portion of the graphene scroll of the hot air blower according to an embodiment of the disclosure;

FIG. 7 is an enlarged view of a portion of the graphene scroll of the hot air blower according to an embodiment of the disclosure;

FIG. 8 is a view illustrating a heater included in a hot air blower according to an embodiment of the disclosure;

FIG. 9 is a view illustrating a graphene sheet forming a graphene scroll of FIG. 8 and electrodes connected to the graphene sheet according to an embodiment of the disclosure;

FIG. 10 is a view illustrating a heater included in a hot air blower, particularly illustrating the heater including a plurality of graphene scrolls according to an embodiment of the disclosure;

FIG. 11 is a cross-sectional view illustrating the plurality of graphene scrolls of the heater of FIG. 10 according to an embodiment of the disclosure;

FIG. 12 is a view illustrating graphene sheets each forming the plurality of graphene scrolls included in the hot air blower, and electrodes each connected to the graphene sheets according to an embodiment of the disclosure;

FIG. 13 is a view illustrating graphene sheets each forming the plurality of graphene scrolls included in the hot air blower, and electrodes each connected to the graphene sheets according to an embodiment of the disclosure;

FIG. 14 is an enlarged view of a portion of the plurality of graphene scrolls included in the hot air blower according to an embodiment of the disclosure;

FIG. 15 is an enlarged view of a portion of a plurality of graphene scrolls included in a hot air blower according to an embodiment of the disclosure;

FIG. 16 is a view illustrating a heater, which is included in a hot air blower, including a plurality of graphene scrolls according to an embodiment of the disclosure;

FIG. 17 is a cross-sectional view illustrating a portion of a hot air blower according to an embodiment of the disclosure;

FIG. 18 is a view schematically illustrating a water purifier according to an embodiment of the disclosure;

FIG. 19 is a view illustrating a dispenser and a heater of the water purifier according to an embodiment of the disclosure;

FIG. 20 is a cross-sectional view illustrating the dispenser and the heater of the water purifier according to an embodiment of the disclosure;

FIG. 21 is a block diagram illustrating some components of the water purifier according to an embodiment of the disclosure; and

FIG. 22 is a cross-sectional view illustrating a portion of a water purifier according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, the same reference numerals or signs shown in the drawings of the disclosure indicate elements or components performing substantially the same function. Shapes and sizes of elements in the drawings may be exaggerated for clear description.

Also, the terms used herein are used to describe the embodiments and are not intended to limit and/or restrict the disclosure. In this disclosure, the terms “including”, “having”, and the like are used to specify features, numbers, steps, operations, elements, components, or combinations thereof, but do not preclude the presence or addition of one or more of the features, numbers, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

Terms such as “unit,” “module,” “member,” and “block” may be embodied as hardware or software. According to embodiments, a plurality of “unit,” “module,” “member,” and “block” may be implemented as a single component or a single “unit,” “module,” “member,” and “block” may include a plurality of components.

It will be understood that when an element is referred to as being “connected” another element, it can be directly or indirectly connected to the other element, wherein the indirect connection includes “connection via a wireless communication network.”

The disclosure will be described more fully hereinafter with reference to the accompanying drawings.

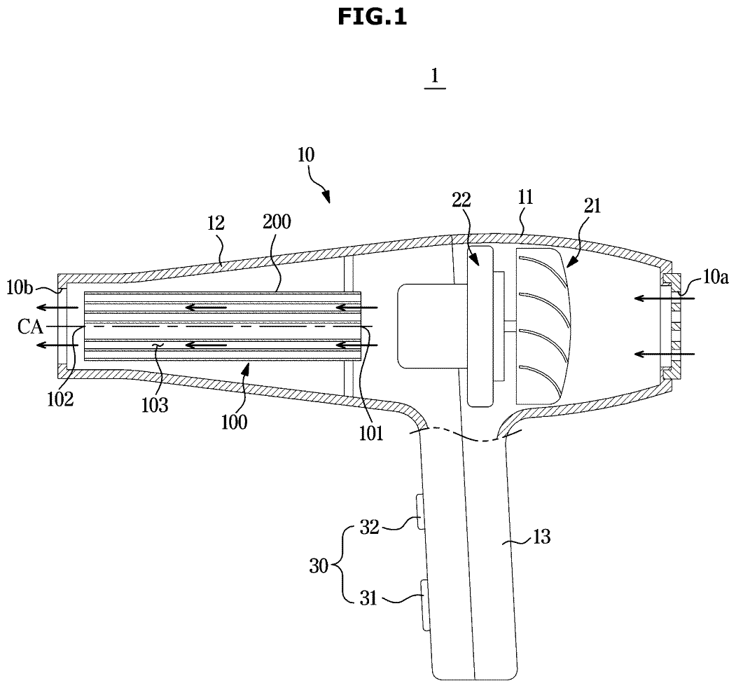

Hereinafter a hair dryer, which is mainly used in the home as a type of hot air blower, will be described as an example with reference to FIGS. 1 to 17. However, a configuration of the disclosure is not limited to a hair dryer and may be applied to a hot air blower used for industrial purposes. Alternatively, the configuration of the disclosure may be applied to a hot air blower as a module for heating air and providing hot air inside various devices such as home appliances, even when the hot air blower is not an independent device by itself.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 1 is a cross-sectional view illustrating a hot air blower according to an embodiment of the disclosure.

Referring to FIG. 1, a hot air blower 1 according to an embodiment of the disclosure may include a main body 10, a fan 21, and a heater 100.

The main body 10 may form an exterior of the hot air blower 1. Various components of the hot air blower 1 may be disposed inside the main body 10. The main body 10 may receive and support various components of the hot air blower 1.

The main body 10 may form a flow path through which air flows. The flow path may be disposed inside the main body 10. Particularly, the main body 10 may include a main body inlet 10a through which air flows into the main body 10, and a main body outlet 10b through which air is discharged from the inside of the main body 10. The flow path inside the main body 10 may be formed between the main body inlet 10a and the main body outlet 10b. The flow path inside the main body 10 may extend from the main body inlet 10a to the main body outlet 10b, and the air introduced into the main body 10 through the main body inlet 10a may flow along the flow path and then be discharged to the outside of the main body 10 through the main body outlet 10b.

For example, the main body inlet 10a may include one or more holes formed to allow air to pass therethrough. For example, the main body outlet 10b may include one or more holes formed to allow air to pass therethrough.

The fan 21 of the hot air blower 1 may be disposed inside the main body 10. The fan 21 may be disposed inside the main body 10 to be rotatable with respect to the main body 10. The fan 21 may generate a pressure difference to allow air to flow along the flow path inside the main body 10. Particularly, the fan 21 may generate a pressure difference to allow air, which is outside the main body 10, to flow into the main body 10 through the main body inlet 10a when the fan 21 rotates. Further, the fan 21 may generate a pressure difference to allow air, which flows into the main body 10 through the main body inlet 10a, to flow along the flow path inside the main body 10 when the fan 21 rotates. Further, the fan 21 may generate a pressure difference to allow air inside the main body 10 to be discharged to an outside of the main body 10 through the main body outlet 10b when the fan 21 rotates. That is, when the fan 21 rotates relative to the main body 10, air outside the main body 10 may be introduced into through the main body inlet 10a and then discharged through the main body outlet 10b by the pressure difference generated by the fan 21.

The hot air blower 1 may include a fan motor 22 configured to generate power to rotate the fan 21. The fan motor 22 may be configured to convert electromagnetic force into mechanical rotational force. The fan 21 may rotate with respect to the main body 10 by receiving power generated by the fan motor 22.

For example, the fan motor 22 may include a stator with a coil, a rotor having magnetism and configured to be rotated by electromagnetic force, and a rotor shaft connecting the rotor and the fan 21. When a driving voltage is applied to the fan motor 22, the electromagnetic force between the stator and the rotor may be converted into rotational force, thereby allowing the rotor to rotate. Power generated as the rotor rotates may be transmitted to the fan 21 through the rotor shaft, and the fan 21 may rotate around the rotor shaft.

For example, the fan 21 may include various types of fans such as axial fans and centrifugal fans.

The fan 21 and the fan motor 22 may be supported by the main body 10 inside the main body 10. For example, the main body 10 may include a fan housing 11 in which the fan 21 and the fan motor 22 are received. The fan 21 and the fan motor 22 may be supported by the fan housing 11. At least a portion of a flow path of air flowing from the main body inlet 10a to the main body outlet 10b may be formed in the fan housing 11.

For example, the above-described main body inlet 10a may be formed in the fan housing 11.

The heater 100 of the hot air blower 1 may be configured to generate heat. The heater 100 may be configured to heat air by generating heat. The heater 100 may be configured to generate heat based on a voltage being applied.

The heater 100 may be disposed in the main body 10. The heater 100 may be configured to heat air flowing through an internal flow path of the main body 10. The heater 100 may be configured to heat air that is introduced through the main body inlet 10a and flows toward the main body outlet 10b when the fan 21 rotates.

For example, the main body 10 may include a duct 12. The duct 12 may be arranged between the main body inlet 10a and the main body outlet 10b. At least a portion of a flow path of air flowing from the main body inlet 10a to the main body outlet 10b may be formed in the duct 12.

The duct 12 may be connected to the fan housing 11. The inside of the duct 12 and the inside of the fan housing 11 may be connected to each other. For example, the above-described main body outlet 10b may be formed in the duct 12. That is, when the fan 21 rotates, the air introduced through the main body inlet 10a of the fan housing 11 may sequentially pass through the fan housing 11 and the duct 12, and be discharged through the main body outlet 10b.

At this time, as illustrated in FIG. 1, the heater 100 may be disposed inside the duct 12. That is, the heater 100 may be configured to heat air flowing along the duct 12.

The heater 100 may be supported by the duct 12. Although not shown in FIG. 1, various structures to support the heater 100 may be provided inside the duct 12. For example, a heater support portion provided to surround an outer circumferential surface of the heater 100 to fix the heater 100 may be disposed inside the duct 12. The heater support portion may be coupled to an inner circumferential surface of the duct 12. Alternatively, the heater support portion may be formed integrally with the inner circumferential surface of the duct 12.

The heater 100 may include an inlet 101 through which air flows into the heater 100, and an outlet 102 through which air is discharged from the heater. When the fan 21 rotates and air flows inside the main body 10, the air may flow into the heater 100 through the inlet 101, be heated, and then be discharged through the outlet 102.

The inlet 101 may be located downstream of the flow path from the main body inlet 10a. The outlet 102 may be located upstream of the flow path from the main body outlet 10b. The inlet 101 may be located upstream of the flow path from the outlet 102.

The inlet 101 may be disposed on one side of the heater 100. For example, the inlet 101 may be disposed on one side, which is adjacent to the fan 21, of the heater 100. For example, the inlet 101 may be disposed on one side, which is adjacent to the main body inlet 10a, of the heater 100.

The outlet 102 may be disposed on the other side opposite to one side in which the inlet 101 of the heater 100 is located. For example, the outlet 102 may be disposed on one side, which is adjacent to the main body outlet 10b, of the heater 100.

For example, a width of the inlet 101 may substantially correspond to a width of the outlet 102. In other words, a cross-sectional area of the inlet 101 may substantially correspond to a cross-sectional area of the outlet 102.

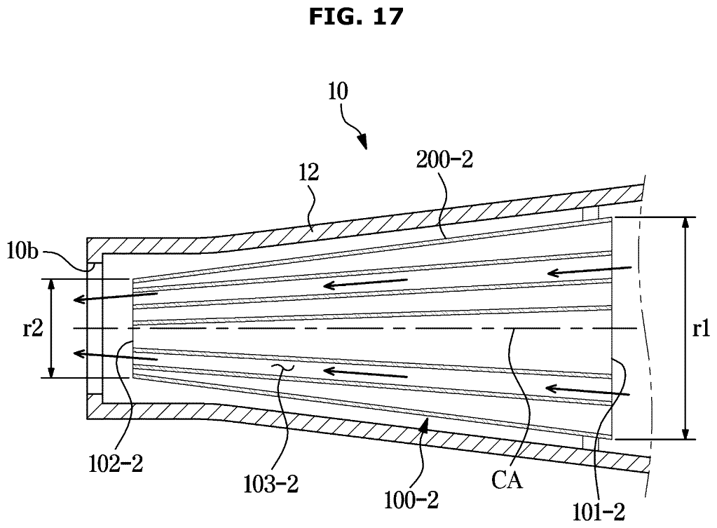

Alternatively, the width of the inlet 101 may be different from the width of the outlet 102. For example, the width of the inlet 101 may be greater or less than the width of the outlet 102 (for example, refer to FIG. 17).

The heater 100 may be formed to have a bar shape extending in one direction. For example, the heater 100 may extend linearly between the inlet 101 and the outlet 102 along a direction in which the inlet 101 and the outlet 102 face each other. However, the disclosure is not limited thereto, and the heater 100 may extend between the inlet 101 and the outlet 102 to have a shape in which at least a portion of the heater 100 is curved.

The heater 100 may form a heating flow path 103. The heating flow path 103 may form at least a portion of the flow path inside the above-described main body 10. The heating flow path 103 may be disposed between the main body inlet 10a and the main body outlet 10b. When the fan 21 rotates, air may pass through the heating flow path 103, and the heater 100 may heat the air passing through the heating flow path 103.

The heating flow path 103 may extend between the inlet 101 and the outlet 102 of the heater 100. The heating flow path 103 may be disposed inside the heater 100. The heating flow path 103 may be provided in a space formed inside the heater 100. The outer circumferential surface of the heater 100 may be formed to have a shape surrounding the heating flow path 103. Heat generated from the heater 100 may be transferred to the heating flow path 103 inside the heater 100 so as to heat the air. When the fan 21 rotates, the air flowing into the heater 100 through the inlet 101 may flow along the heating flow path 103 and then be discharged from the heater 100 through the outlet 102.

For example, the heating flow path 103 may extend in one direction, but is not limited thereto. Alternatively, the direction in which the heating flow path 103 extends may vary according to the shape of the heater 100, the positions of the inlet 101 and the outlet 102, and the like.

As mentioned above, as the fan 21 rotates, air may be introduced/discharged and the heater 100 may heat the air by generating heat. Accordingly, the hot air blower 1 may supply hot air.

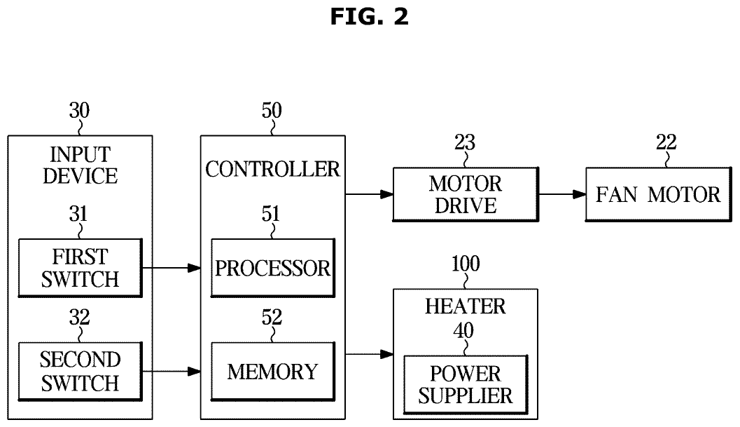

The hot air blower 1 may include a handle 13. The handle 13 may be provided to be easily held by a user. A user can lift or move the hot air blower 1 by holding the handle 13. For example, the handle 13 may be provided with switches 31 and 32, which will be described later. For example, various electronic components may be disposed inside the handle 13. For example, electronic components forming a controller 50 (refer to FIG. 2), a motor drive 23 (refer to FIG. 2), and a power supplier 40 (refer to FIG. 2) to be described later may be arranged inside the handle 13.

For example, electronic components disposed inside the handle 13 may be connected to the fan motor 22, the heater 100, and the like by wires. For this, an inside of the handle 13, an inside of the fan housing 11, and an inside of the duct 12 may be connected to each other.

The configuration of the hot air blower 1 described above with reference to FIG. 1 is only an embodiment of the configuration of the hot air blower according to the disclosure, and the disclosure is not limited thereto.

For example, an embodiment, in which the heater 100 is installed inside the duct 12 to heat air at a location very close to the main body outlet 10b, is illustrated in FIG. 1, but the location of the heater 100 is not limited thereto. The heater 100 may be arranged at various locations within the main body 10 to heat air.

FIG. 2 is a block diagram illustrating some components of the hot air blower according to an embodiment of the disclosure.

Referring to FIG. 2, the hot air blower 1 according to an embodiment of the disclosure may include the controller 50 configured to control various components of the hot air blower 1.

The controller 50 may include a processor 51 configured to generate a control signal related to the operation of the hot air blower 1, and memory 52 configured to store programs, applications, instructions, and/or data for the operation of the hot air blower 1. The processor 51 and the memory 52 may be implemented as separate semiconductor devices or as a single semiconductor device.

Further, the controller 50 may include a plurality of processors or a plurality of memories. The controller 50 may be disposed at various locations inside the hot air blower 1.

The processor 51 may include arithmetic circuitry, memory circuitry, and control circuitry. The processor 51 may include one chip or multiple chips. Additionally, the processor 51 may include one core or a plurality of cores.

The memory 52 may store various programs and data required for control, and may temporarily store temporary data generated during control.

The memory 52 may include volatile memory such as Static Random Access Memory (S-RAM), and Dynamic Random Access Memory (D-RAM), and non-volatile memory such as Read Only Memory (ROM), and Erasable Programmable Read Only Memory (EPROM). The memory 52 may include one memory element or a plurality of memory elements.

The processor 51 may be electrically connected to the memory 52. The processor 51 may process data and/or signals using a program provided from the memory 52, and may transmit control signals to each component of the hot air blower 1 based on the processing results. Each component of the hot air blower 1 may be operated based on a control signal from the processor 51.

The hot air blower 1 may include an input device 30 for receiving a user input. Types of user input that is received through the input device 30 may include on/off of the power of the hot air blower 1, wind strength (that is, rotation speed of the fan 21), wind temperature (that is, heat generation level of the heater 100), and the like.

The input device 30 may include various types of input devices such as a tact switch, a push switch, a slide switch, a toggle switch, a micro switch, or a touch switch.

The input device 30 may receive a user input, output an electrical signal (voltage or current) corresponding to the user input, and transmit the electrical signal to the controller 50. The controller 50 may receive a user input based on the output signal of the input device 30.

For example, the input device 30 may include a first switch 31 and a second switch 32. The first switch 31 and the second switch 32 may be configured to obtain different types of user input.

For example, the first switch 31 may obtain a user input including on/off of the power of the hot air blower 1, wind strength, and the like.

For example, the second switch 32 may obtain a user input including wind temperature, and the like.

The hot air blower 1 may include the motor drive 23 configured to apply a driving voltage to the fan motor 22. The motor drive 23 may be electrically connected to the fan motor 22.

The controller 50 may be electrically connected to the motor drive 23. The controller 50 may control the motor drive 23 to apply or not apply a driving voltage to the fan motor 22 based on a predetermined condition. The motor drive 23 may receive a target speed command or a torque command from the controller 50, and may apply a driving voltage corresponding to the target speed command or the target torque command to the fan motor 22.

The predetermined condition may include a user input obtained through the first switch 31. For example, when a user input, which is for turning on the power of the hot air blower 1 and for blowing wind of a specific strength, is obtained through the first switch 31, the controller 50 may control the motor drive 23 to allow the fan motor 22 to rotate at a rotation speed corresponding to the wind of the corresponding strength. Further, when a user input, which is for turning off the power of the hot air blower 1, is obtained through the first switch 31, the controller 50 may control the motor drive 23 to allow the rotation of the fan motor 22 to stop.

The heater 100 may include the power supplier 40. The power supplier 40 may be configured to apply a voltage to a graphene scroll 200 of the heater 100. The power supplier 40 may be configured to apply a voltage to electrodes 300 of the heater 100. The power supplier 40 may be electrically connected to the electrodes 300 of the heater 100. Particularly, the power supplier 40 may be electrically connected to a plurality of electrodes 300 provided in the heater 100. The power supplier 40 may be configured to apply or not apply a voltage between the plurality of electrodes 300.

The controller 50 may be electrically connected to the power supplier 40. The controller 50 may control the power supplier 40 to apply or not apply a voltage between the plurality of electrodes 300 based on a predetermined condition.

The predetermined condition may include a user input obtained through the second switch 32. For example, when a user input, which is for discharging high-temperature wind, is obtained through the second switch 32, the controller 50 may control the power supplier 40 to allow a voltage to be applied between the plurality of electrodes 300 to allow the heater 100 to heat air at a temperature within a predetermined range. Further, when a user input, which is for discharging low-temperature wind, is obtained through the second switch 32, the controller 50 may control the power supplier 40 to allow a voltage not to be applied between the plurality of electrodes 300 or to allow a magnitude of voltage to be reduced.

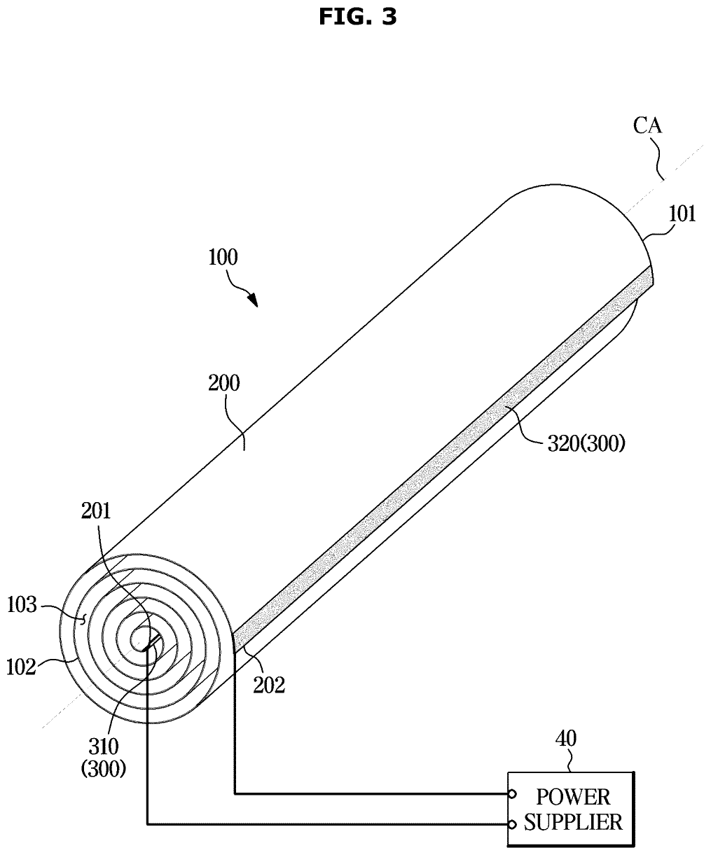

FIG. 3 is a view illustrating a heater included in the hot air blower according to an embodiment of the disclosure.

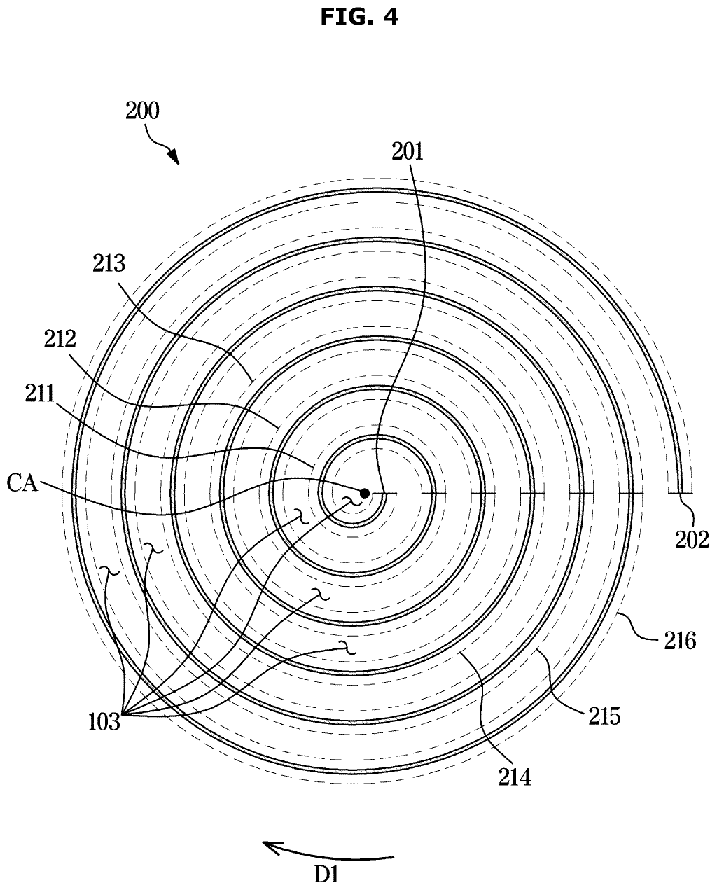

FIG. 4 is a cross-sectional view illustrating a graphene scroll of the heater included in the hot air blower according to an embodiment of the disclosure.

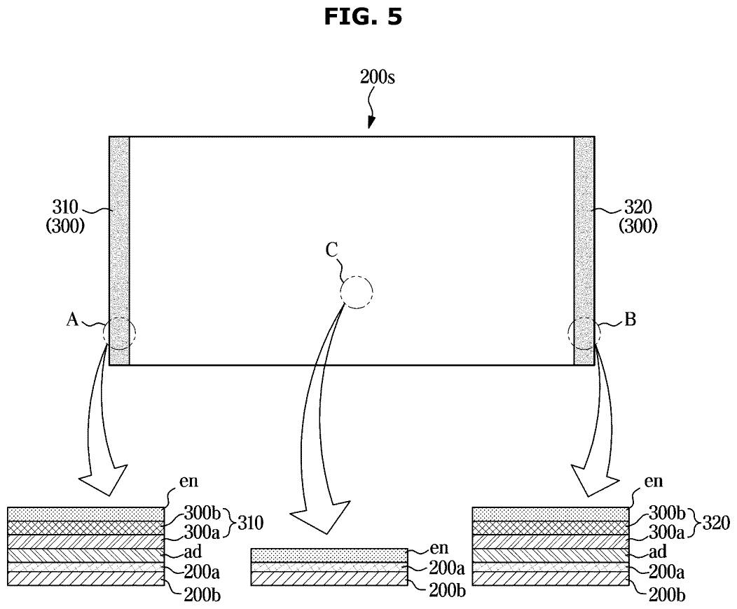

FIG. 5 is a view illustrating a graphene sheet forming the graphene scroll of FIG. 3 and electrodes connected to the graphene sheet according to an embodiment of the disclosure.

Referring to FIGS. 3 to 5, the heater 100 of the hot air blower 1 according to various embodiments of the disclosure may include the graphene scroll 200. The graphene scroll 200 may be configured to generate heat. The graphene scroll 200 may be configured to generate heat when a current flows. The graphene scroll 200 may be configured to heat air that is moved by the fan 21. The graphene scroll 200 may be configured to heat air passing through the heating flow path 103.

The graphene scroll 200 may be formed of a material containing graphene. The graphene scroll 200 may be formed using a graphene sheet 200s (refer to FIG. 5) formed of a material containing graphene. As illustrated in FIG. 5, the graphene sheet 200s may be formed in a substantially planar shape. For example, the graphene sheet 200s may be formed into a thin sheet shape having a substantially rectangular shape. A detailed description of the structure of the graphene sheet 200s will be described later.

Graphene may refer to a thin film laminated approximately 1 to 10 layers based on a single atomic layer in which carbon atoms are bonded in a hexagonal lattice shape (honeycomb structure). Graphene is one of the allotropes of carbon, and may have a structure in which carbon atoms come together to form a two-dimensional plane.

When a voltage is applied to the graphene, a current may flow through the graphene, and heat may be generated due to the resistance that graphene has. Due to this characteristic, when a voltage is applied to the graphene scroll 200 and a current flows, the graphene scroll 200 may generate heat due to the current resistance.

The graphene has high electrical conductivity and thus when a voltage is applied, the power consumption rate is low but the heat generation efficiency is relatively high. Additionally, the graphene has high thermal conductivity and excellent heat transfer efficiency. Accordingly, the graphene scroll 200 may have high air heating efficiency.

Additionally, due to the characteristics of graphene, the graphene scroll 200 may be configured to rapidly heat air when a voltage is applied. Conversely, the graphene scroll 200 may be configured to quickly return to an original temperature thereof when the voltage application is blocked.

As mentioned above, when using the graphene scroll 200 as a heat source of the heater 100, it is possible to easily control whether or not heat is generated according to whether a voltage is applied. In addition, even when the graphene scroll 200 does not heat air, the temperature of the graphene scroll 200 may be easily lowered by cutting off the power, thereby preventing the heater 100 and a vicinity of the heater 100 from being damaged by high heat.

Additionally, the graphene has the characteristic of high physical strength, and thus the graphene scroll 200 may not be easily damaged by external impact.

In addition, in comparison with a type that is heated by a heating wire on which a current flows, when a voltage is applied to the graphene scroll 200, a current may flow through the entire area of the graphene scroll 200 and heat may be generated in the entire area of the graphene scroll 200 due to the characteristics of graphene. Accordingly, even when a portion of the graphene scroll 200 is damaged, the remaining portion thereof may generate heat by application of a voltage.

Further, the graphene has the characteristic of having a very high surface area per particle unit, and thus it may be easier to manufacture a lightweight heater when using the graphene scroll 200.

The graphene scroll 200 may be provided to allow a fluid to pass therethrough. Particularly, in the hot air blower 1, the graphene scroll 200 may be provided to allow air to pass therethrough. The graphene scroll 200 may form the heating flow path 103. The heating flow path 103 may be formed in an inner space of the graphene scroll 200.

Particularly, the graphene scroll 200 may include the inlet 101 described above. The inlet 101 may be formed to allow air to flow into the graphene scroll 200. The inlet 101 may be disposed on one side of the graphene scroll 200.

The graphene scroll 200 may include the outlet 102 described above. The outlet 102 may be formed to discharge air from the graphene scroll 200. The outlet 102 may be disposed on the other side of the graphene scroll 200 opposite to the inlet 101.

The heating flow path 103 may extend from the inlet 101 to the outlet 102.

The heating flow path 103 may extend in a direction corresponding to the direction in which the graphene scroll 200 extends. Additionally, a length in which the heating flow path 103 extends may correspond to a length in which the graphene scroll 200 extends.

The graphene scroll 200 may be composed of a planar heating element. The planar heating element may be not limited to a heating element having an overall planar shape, but may include a shape in which even when a component has a curved shape, such as the graphene scroll 200 shown in FIG. 3, a portion of the component has a thin surface shape.

As the graphene scroll 200 is composed of a planar heating element as mentioned above, an area, in which the graphene scroll 200 comes into contact with air, may increase, and an overall heat generation area/heat transfer area of the graphene scroll 200 may increase. In other words, an area in which the graphene scroll 200 comes into contact with the heating flow path 103 may increase. Accordingly, the air heating efficiency by the graphene scroll 200 may be improved.

The heating flow path 103 formed by the graphene scroll 200 may have a central axis (CA). The central axis (CA) of the heating flow path 103 may extend between the inlet 101 and the outlet 102. The central axis (CA) of the heating flow path 103 may be an axis that passes through the center of the heating flow path 103 and that passes through the inlet 101 and the outlet 102, and may mean a central axis extending in the direction in which the air flows along the heating flow path 103. The central axis of the heating flow path 103 may coincide with a central axis of the graphene scroll 200.

For example, as illustrated in FIG. 3, when the inlet 101 and the outlet 102 are parallel to each other in one direction, in other words, when a direction in which air is introduced through the inlet 101, a direction in which air flows along the heating flow path 103, and a direction in which air is discharged through the outlet 102 are parallel to each other, the heating flow path 103 may have a shape extending in one direction, and the central axis (CA) of the heating flow path 103 may extend in the same direction. However, when the inlet 101 and the outlet 102 are not parallel to each other or the heating flow path 103 extending between the inlet 101 and the outlet 102 has a curved shape in at least some regions, the central axis (CA) of the heating flow path 103 may also have a curved shape at least in part.

The graphene scroll 200 may extend to allow a distance from the central axis (CA) to increase from one end adjacent to the central axis (CA) of the heating flow path 103 toward the other end. Particularly, the graphene scroll 200 may include a first end 201 parallel to the central axis (CA) of the heating flow path 103 and a second end 202 opposite to the first end 201. The graphene scroll 200 may be provided to allow the distance from the central axis (CA) to increase as the graphene scroll 200 extends from the first end 201 toward the second end 202. The distance from the central axis (CA) may refer to the shortest distance between the central axis (CA) and a point of the graphene scroll 200 located between the first end 201 and the second end 202.

For example, the first end 201 of the graphene scroll 200 may be parallel to the central axis (CA) of the heating flow path 103. For example, the second end 202 of the graphene scroll 200 may be parallel to the central axis (CA) of the heating flow path 103.

The graphene scroll 200 may extend from the first end 201 toward the second end 202 in a first direction D1. The graphene scroll 200 may extend to allow the distance from the central axis (CA) to increase toward the first direction D1. The first direction D1 is counterclockwise based on FIG. 4, but is not limited thereto. Alternatively, the first direction D1 may be clockwise based on FIG. 4.

The graphene scroll 200 may extend to allow an angle, which is measured in the first direction D1 about the central axis (CA), to increase from the first end 201 to the second end 202.

A portion of the graphene scroll 200 may be covered from an outer direction by other portion. For example, other portion, which is in a position extending in the first direction D1 at 360 degrees or more from one portion of the graphene scroll 200, may cover the one portion from the outer direction. The outer direction may mean a direction adjacent to the outside of the graphene scroll 200 and mean a position farther from the central axis (CA) of the heating flow path 103.

For example, the graphene scroll 200 may be formed in a scroll shape formed by bending a flat graphene sheet 200s into a curved shape. The scroll shape of the graphene scroll 200 may mean a shape formed by winding the graphene sheet 200s in one direction about one axis. For example, the graphene scroll 200 may be formed by winding the graphene sheet 200s from one of the pair of short sides toward the other short side about an axis parallel to the pair of short sides of the graphene sheet 200s. Alternatively, the graphene scroll 200 may be formed by winding the graphene sheet 200s from one of the pair of long sides toward the other long side about an axis parallel to the pair of long sides of the graphene sheet 200s.

Alternatively, lengths of all sides of the graphene sheet 200s may be the same, and in this case, about an axis parallel to one side among sides of the graphene sheet 200s, the graphene scroll 200 may be formed by winding the graphene sheet 200s from the one side toward one side opposite to the one side.

Referring to FIG. 4, the graphene scroll 200 may include a first portion 211. The first portion 211 of the graphene scroll 200 may extend in the first direction D1 from one side adjacent to the central axis (CA) of the heating flow path 103 toward the other side. The first portion 211 of the graphene scroll 200 may extend to allow the distance from the central axis (CA) to increase toward the first direction D1.

Additionally, the graphene scroll 200 may include a second portion 212. The second portion 212 of the graphene scroll 200 may extend from the first portion 211 in the first direction D1. The second portion 212 of the graphene scroll 200 may extend in the first direction D1 from one side of the second portion 212 adjacent to the central axis (CA) to the other side. The second portion 212 of the graphene scroll 200 may extend to allow the distance from the central axis (CA) to increase toward the first direction D1.

At this time, the second portion 212 of the graphene scroll 200 may cover the first portion 211 from the outer direction.

Further, the graphene scroll 200 may further include a third portion 213 extending from the second portion 212 in the first direction D1 and covering the second portion 212 from the outer direction, a fourth portion 214 extending from the third portion 213 in the first direction D1 and covering the third portion 213 from the outer direction, a fifth portion 215 extending from the fourth portion 214 in the first direction D1 and covering the fourth portion 214 from the outer direction, and a sixth portion 216 extending from the fifth portion 215 in the first direction D1 and covering the fifth portion 215 from the outer direction. The third portion 213, the fourth portion 214, the fifth portion 215, and the sixth portion 216 of the graphene scroll 200 may extend to allow a distance from the central axis (CA) to increase toward the first direction D1.

With this structure, the graphene scroll 200 may have a scroll shape in which the graphene sheet 200s is wound about a single axis.

FIG. 4 illustrates an embodiment in which the graphene scroll 200 extends in the first direction D1 at 360 degrees by approximately six times, but the disclosure is not limited thereto. For example, unlike FIG. 4, the graphene scroll 200 may include only the first portion 211 and the second portion 212. Alternatively, unlike FIG. 4, the graphene scroll 200 may further include a portion extending from the sixth portion 216 to the first direction D1.

In addition, FIG. 4 illustrates an example in which each portion of the graphene scroll 200, such as the first portion 211 and the second portion 212, extends at approximately 360 degrees about the central axis (CA), but this is only an example, in which each portion of the graphene scroll 200 is divided, for convenience of description. Therefore, the disclosure is not limited by the angle at which each portion of the graphene scroll 200 extends.

The graphene scroll 200 may have a shape in which one surface of one portion extends without being in contact with other portion that covers the one portion. In other words, one portion of the graphene scroll 200 and other portion covering the one portion may be spaced apart in a direction away from the central axis (CA). In other words, a space may be formed between one portion of the graphene scroll 200 and other portion covering the one portion, and air may flow through the space. That is, at least a portion of the heating flow path 103 may be formed between one portion of the graphene scroll 200 and other portion covering the one portion of the graphene scroll 200.

Referring to FIG. 4, the second portion 212 of the graphene scroll 200 may be disposed at a position spaced apart from the first portion 211 in the direction away from the central axis (CA). At this time, at least a portion of the heating flow path 103 may be formed in the space between the first portion 211 and the second portion 212. Additionally, at least a portion of the heating flow path 103 may be formed in an inner space of the first portion 211 (that is, a space surrounded by the first portion 211 of the graphene scroll 200).

In the same manner as the above mention, the third portion 213 of the graphene scroll 200 may be disposed at a position spaced apart from the second portion 212 in the direction away from the central axis (CA), and at least a portion of the heating flow path 103 may be formed in a space between the second portion 212 and the third portion 213. In addition, the fourth portion 214 of the graphene scroll 200 may be disposed at a position spaced apart from the third portion 213 in the direction away from the central axis (CA), and at least a portion of the heating flow path 103 may be formed in a space between the third portion 213 and the fourth portion 214. In addition, the fifth portion 215 of the graphene scroll 200 may be disposed at a position spaced apart from the fourth portion 214 in the direction away from the central axis (CA), and at least a portion of the heating flow path 103 may be formed in a space between the fourth portion 214 and the fifth portion 215. In addition, the sixth portion 216 of the graphene scroll 200 may be disposed at a position spaced apart from the fifth portion 215 in the direction away from the central axis (CA), and at least a portion of the heating flow path 103 may be formed in a space between the fifth portion 215 and the sixth portion 216.

At this time, portions of the heating flow path 103 formed between each portion of the graphene scroll 200 may be connected to each other. In other words, a portion of the heating flow path 103 formed in the inner space of the first portion 211 of the graphene scroll 200, a portion of the heating flow path 103 formed between the first portion 211 and the second portion 212 of the graphene scroll 200, a portion of the heating flow path 103 formed between the second portion 212 and the third portion 213 of the graphene scroll 200, a portion of the heating flow path 103 formed between the third portion 213 and the fourth portion 214 of the graphene scroll 200, a portion of the heating flow path 103 formed between the fourth portion 214 and the fifth portion 215 of the graphene scroll 200, and a portion of the heating flow path 103 formed between the fifth portion 215 and the sixth portion 216 of the graphene scroll 200 may be connected to each other.

With the structure of the graphene scroll 200, an area, in which the graphene scroll 200 comes into contact with the heating flow path 103, may be increased, and a heat generation area of the graphene scroll 200 to a volume occupied by the graphene scroll 200 may be increased. Accordingly, the graphene scroll 200 may heat air more efficiently.

The graphene has high durability and flexibility due to the characteristics thereof, and thus it may be easy to manufacture the graphene scroll 200 with the above-described structure using the planar graphene sheet 200s.

The graphene scroll 200 may be configured to heat air that is introduced through the inlet 101 and flows along the heating flow path 103 toward the outlet 102. Accordingly, as the length of the heating flow path 103 between the inlet 101 and the outlet 102 is increased, it is easier to secure time to heat the air. Therefore, as illustrated in FIG. 3, the graphene scroll 200 may have the shape of a bar extending between the inlet 101 and the outlet 102. For example, as illustrated in FIG. 3 the graphene scroll 200 may have the shape of a bar extending in one direction between the inlet 101 and the outlet 102. Accordingly, the graphene scroll 200 may be referred to as a ‘graphene bar’.

As described above, the graphene scroll 200 may be configured to generate heat based on a voltage being applied. The heater 100 may include the power supplier 40 configured to apply a voltage to the graphene scroll 200. For example, the power supplier 40 may be configured to apply alternating current power, but is not limited thereto. Alternatively, the power supplier 40 may be configured to apply direct current power. The power supplier 40 may be controlled by the controller 50 (refer to FIG. 2) to apply a voltage to the graphene scroll 200. The power supplier 40 may also be referred to as the ‘heater drive 40’.

For example, the power supplier 40 may be connected to an external power source and receive power from the external power source. Alternatively, the power supplier 40 may receive power by being connected to a battery that charges power.

For example, the power supplier 40 may include electronic components for applying a voltage to the graphene scroll 200, and a printed circuit board on which the electronic components are mounted.

The heater 100 may include the plurality of electrodes 300. The plurality of electrodes 300 may be configured to apply a voltage to the graphene scroll 200. The plurality of electrodes 300 may each be in contact with the graphene scroll 200 to apply a voltage to the graphene scroll 200.

Each of the plurality of electrodes 300 may be electrically connected to the power supplier 40. For example, each of the plurality of electrodes 300 may be electrically connected to the power supplier 40 through a wire. The plurality of electrodes 300 may each be connected to the power supplier 40, and the power supplier 40 may generate a potential difference between the plurality of electrodes 300 or remove the potential difference. The graphene scroll 200 may receive power from the power supplier 40 through the plurality of electrodes 300.

When a voltage is applied between the plurality of electrodes 300, an electric field may be generated in a region of the graphene scroll 200 located between the plurality of electrodes 300. As a result, a current may flow in the region, which is located between the plurality of electrodes 300, of the graphene scroll 200, and heat due to resistance may be generated in the region. Accordingly, the graphene scroll 200 may be configured to generate heat based on a voltage being applied.

Referring to FIGS. 3 and 5, the plurality of electrodes 300 may include a pair of counter electrodes 310 and 320. The pair of counter electrodes 310 and 320 may be arranged to be spaced apart from each other. For example, one of the pair of counter electrodes 310 and 320 may be disposed adjacent to the first end 201 of the graphene scroll 200, and the other counter electrode 320 may be disposed adjacent to the second end 202 of the graphene scroll 200. In FIG. 3, it is illustrated that the pair of counter electrodes 310 and 320 are disposed at opposite ends of the graphene scroll 200, respectively. Alternatively, the pair of counter electrodes 310 and 320 may be disposed in a location spaced apart from opposite ends of the graphene scroll 200.

The pair of counter electrodes 310 and 320 may each be electrically connected to the power supplier 40. A circuit including the pair of counter electrodes 310 and 320 and the power supplier 40 may be configured in various ways and thus whether or not a voltage is applied between the pair of counter electrodes 310 and 320 may vary according to the operation of the power supplier 40.

The plurality of electrodes 300 may extend in directions parallel to each other. As each of the plurality of electrodes 300 extends in the directions parallel to each other, the amount of heat generated in a region, which is between the plurality of electrodes 300, of the graphene scroll 200 may be maintained constant throughout.

For example, as illustrated in FIGS. 3 and 5, each of the plurality of electrodes 300 may extend in a direction parallel to the direction in which the heating flow path 103 extends. Particularly, each of the plurality of electrodes 300 may extend in a direction parallel to the direction in which the heating flow path 103 extends from the inlet 101 toward the outlet 102. Each of the plurality of electrodes 300 may extend in a direction substantially parallel to the central axis (CA) of the heating flow path 103.

For example, as illustrated in FIG. 3, a first side electrode 310 of the pair of counter electrodes 310 and 320 may extend along the first end 201 of the graphene scroll 200. The first side electrode 310 of the pair of counter electrodes 310 and 320 may be in contact with the first end 201 of the graphene scroll 200 and spaced apart from the second end 202.

For example, as illustrated in FIG. 3, a second side electrode 320 of the pair of counter electrodes 310 and 320 may extend along the second end 202 of the graphene scroll 200. The second side electrode 320 of the pair of counter electrodes 310 and 320 may be in contact with the second end 202 of the graphene scroll 200 and spaced apart from the first end 201.

For example, when the graphene sheet 200s has a rectangular shape as illustrated in FIG. 5, each of the pair of counter electrodes 310 and 320 may extend in a direction parallel to the short side of the graphene sheet 200s. In this case, the central axis (CA) of the heating flow path 103 may be parallel to the short side of the graphene sheet 200s. Alternatively, according to the shape of the graphene sheet 200s, the central axis (CA) of the heating flow path 103 may be parallel to the long side of the graphene sheet 200s, and in this case, the pair of counter electrodes 310 and 320 may extend in a direction parallel to the long side of the graphene sheet 200s. Alternatively, the graphene sheet 200s may have a substantially square shape.

The structure of the graphene sheet 200s forming the graphene scroll 200 will be described in more detail with reference to FIG. 5.

A of FIG. 5 illustrates an enlarged view of each layer by cutting the first side electrode 310 of the pair of counter electrodes 310 and 320 and a portion of the graphene sheet 200s in contact with the first side electrode 310. B of FIG. 5 illustrates an enlarged view of each layer by cutting the second side electrode 320 of the pair of counter electrodes 310 and 320 and a portion of the graphene sheet 200s in contact with the second side electrode 320. C of FIG. 5 illustrates an enlarged view of each layer by cutting a portion of the graphene sheet 200s located between the pair of counter electrodes 310 and 320.

The structure of A and the structure of B of FIG. 5 may correspond to each other.

Referring to A, B and C of FIG. 5, the graphene sheet 200s may include a graphene layer 200a in which graphene is arranged in at least one layer, and a base layer 200b supporting the graphene layer 200a. That is, the graphene scroll 200 may include the graphene layer 200a and the base layer 200b.

The graphene layer 200a may be configured to generate heat through resistance when a voltage is applied and a current flows. At this time, a thickness of one layer of graphene may be approximately 0.2 nanometers, and a thickness of the graphene layer 200a provided on the graphene sheet 200s may be 10 micrometers or less. Because the graphene layer 200a is very thin, the graphene sheet 200s may need the base layer 200b to support the graphene layer 200a. For example, the base layer 200b may have a thickness of approximately 50 micrometers. The base layer 200b may be formed in the shape of a thin film on which the graphene layer 200a is attached to support the graphene layer 200a.

The graphene layer 200a may be coupled to one surface of the base layer 200b. For example, the graphene layer 200a and the base layer 200b may be coupled to each other by intermolecular forces (van der Waals force, and the like).

Because the graphene layer 200a is a portion that generates heat when a voltage is applied, the base layer 200b may be formed of a material with high heat resistance. For example, the base layer 200b may be formed of a material containing polyamide, but is not limited thereto. Alternatively, the base layer 200b may be formed of various materials such as a resin material containing polyethylene terephthalate (PET).

Due to the flexible nature of graphene, the graphene layer 200a may have high flexibility. Additionally, the base layer 200b may be provided to be highly flexible. For example, the base layer 200b may be formed of a film composed of a material containing the above-described polyimide, polyethylene terephthalate, and the like. Accordingly, it may be easy to bend the graphene layer 200a and the base layer 200b.

Referring to A and B of FIG. 5, the plurality of electrodes 300 may each be coupled to the graphene sheet 200s. Particularly, the plurality of electrodes 300 may each be attached to the graphene layer 200a. The plurality of electrodes 300 may be attached to one surface of the graphene layer 200a that is opposite to the other surface of the graphene layer 200a coupled to the base layer 200b. Accordingly, each of the plurality of electrodes 300 may be electrically connected to the graphene layer 200a, and when a voltage is applied between the plurality of electrodes 300, a current may flow in the graphene layer 200a.

Referring to A and B of FIG. 5, each of the plurality of electrodes 300 may be coupled to the graphene sheet 200s by an adhesive layer (ad). Each of the plurality of electrodes 300 may be attached to the graphene layer 200a by the adhesive layer (ad). The adhesive layer (ad) may be arranged between the graphene layer 200a and the electrode 300. The adhesive layer (ad) may be provided to have high electrical conductivity so as to electrically connect each of the plurality of electrodes 300 to the graphene layer 200a.

For example, the adhesive layer (ad) may include various types of conductive adhesives such as silver paste.

For example, the adhesive layer (ad) may have a thickness of approximately 10 micrometers or less.

However, the disclosure is not limited thereto, and each of the plurality of electrodes 300 may be coupled to the graphene layer 200a in various ways.

For example, referring to A and B of FIG. 5, each of the plurality of electrodes 300 may include a contact electrode 300a. The contact electrode 300a may be in contact with the graphene sheet 200s and electrically connected to the graphene sheet 200s. Particularly, the contact electrode 300a may be attached to one surface that is opposite to the other surface of the graphene layer 200a coupled to the base layer 200b. The contact electrode 300a may be electrically connected to the power supplier 40. The graphene layer 200a may receive a voltage through the plurality of contact electrodes 300a.

The contact electrode 300a may include a conductive material. For example, the contact electrode 300a may include various types of conductive metal materials such as copper.

For example, the contact electrode 300a may have a thickness of approximately 60 micrometers.

For example, the above-described adhesive layer (ad) may be disposed between the contact electrode 300a and the graphene layer 200a. The contact electrode 300a may be attached to the graphene layer 200a by the adhesive layer (ad). The contact electrode 300a may be electrically connected to the graphene layer 200a through the adhesive layer (ad).

For example, referring to A and B of FIG. 5, each of the plurality of electrodes 300 may include a pad electrode 300b. The pad electrode 300b may be electrically connected to the contact electrode 300a. The pad electrode 300b may be coupled to the contact electrode 300a. The pad electrode 300b may be attached to the other surface of the contact electrode 300a that is opposite to one surface of the contact electrode 300a facing the graphene layer 200a. The pad electrode 300b may be electrically connected to the power supplier 40.

The pad electrode 300b may include a conductive material. For example, the pad electrode 300b may be formed by soldering various types of conductive metals such as solder.

For example, the contact electrode 300a and the pad electrode 300b may be coupled to each other using a conductive adhesive such as silver paste. However, the disclosure is not limited thereto, and the contact electrode 300a and the pad electrode 300b may be coupled to each other in various ways.

For example, a wire connecting each of the plurality of electrodes 300 to the power supplier 40 may be connected to the pad electrode 300b and/or the contact electrode 300a. Accordingly, the plurality of electrodes 300 may be electrically connected to the power supplier 40, and the graphene layer 200a may receive a voltage through the plurality of electrodes 300.

Referring to A, B and C of FIG. 5, the graphene sheet 200s may further include an encapsulation layer (en). That is, the graphene scroll 200 may include an encapsulation layer (en). The encapsulation layer (en) may be provided to protect the graphene layer 200a from the outside. The encapsulation layer (en) may be disposed on one side, which is opposite to the base layer 200b, of the graphene layer 200a. The encapsulation layer (en) may be formed through an encapsulation process that surrounds one side, which is opposite to the base layer 200b, of the graphene layer 200a. The encapsulation layer (en) may form one outer surface of the graphene scroll 200.

Referring to A and B of FIG. 5, the encapsulation layer (en) may cover the plurality of electrodes 300, respectively. Particularly, the encapsulation layer (en) may cover the pad electrode 300b of each of the plurality of electrodes 300.

Referring to C of FIG. 5, the encapsulation layer (en) may cover the graphene layer 200a.

In other words, the encapsulation layer (en) may entirely cover one side of the graphene layer 200a and form one surface of the graphene sheet 200s. The plurality of electrodes 300 may be disposed between a portion of the encapsulation layer (en) and a portion of the graphene layer 200a.

The encapsulation layer (en) may be composed of a highly flexible material. The encapsulation layer (en) may be composed of a material with high moisture resistance or heat resistance. For example, the encapsulation layer (en) may include various materials such as resin materials such as epoxy and polyethylene terephthalate (PET).

For example, the encapsulation layer (en) may be formed in the form of a flexible and thin film.

For example, the encapsulation layer (en) may have a thickness of approximately 50 micrometers.

For example, when the graphene sheet 200s is wound to form the graphene scroll 200, the encapsulation layer (en) may be arranged to face the outer direction of the graphene scroll 200 (that is, direction away from the central axis (CA) of the heating flow path 103), and the base layer 200b may be arranged to face an inner direction of the graphene scroll 200 (that is, direction closer to the central axis (CA) of the heating flow path 103).

Alternatively, when the graphene sheet 200s is wound to form the graphene scroll 200, the base layer 200b may be arranged to face the outer direction of the graphene scroll 200 (that is, direction away from the central axis (CA) of the heating flow path 103), and the encapsulation layer (en) may be arranged to face the inner direction of the graphene scroll 200 (that is, direction closer to the central axis (CA) of the heating flow path 103).

The structure of each layer forming the graphene sheet 200s and the plurality of electrodes 300 is not limited to the above-mentioned example. In addition, the thickness and material of each of the layers forming the graphene sheet 200s, the plurality of electrodes 300, and the like are not limited to those described above.

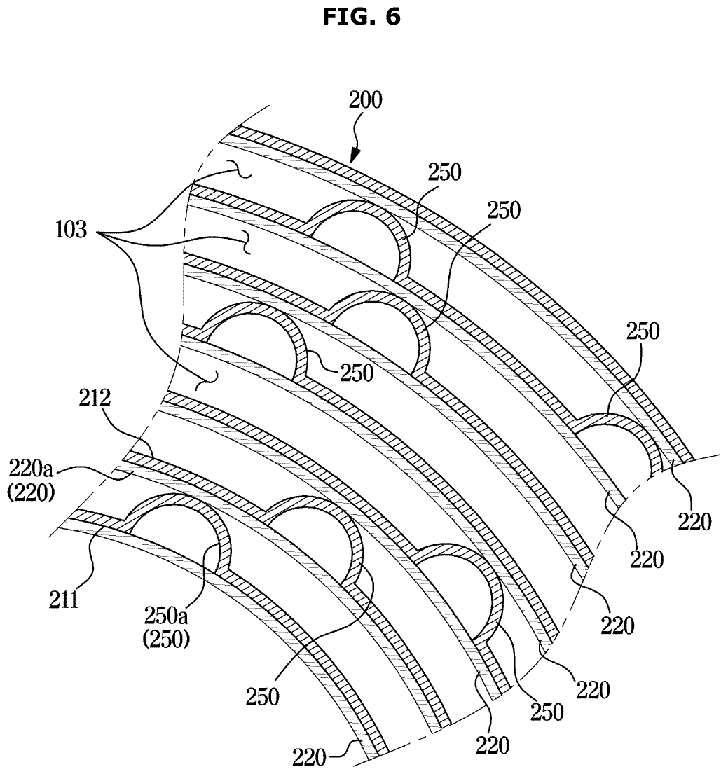

FIG. 6 is an enlarged view of a portion of the graphene scroll of the hot air blower according to an embodiment of the disclosure.

Referring to FIG. 6, the heater 100 according to an embodiment of the disclosure may further include a spacer 250. The spacer 250 may be provided to maintain a separation space between one portion of the graphene scroll 200 and other portion covering the one portion from the outer direction. The spacer 250 may be provided to support one portion of the graphene scroll 200 or other portion covering the one portion from the outer direction. The spacer 250 may be disposed within the heating flow path 103.

Due to the flexible nature of graphene, it is easy to manufacture curved shapes such as the graphene scroll 200. However, due to this flexibility, a structure that maintains the shape may be required. The spacer 250 may prevent an internal space of the graphene scroll 200 from being deformed caused by the flexibility of graphene.

For example, the spacer 250 may protrude from one portion of the graphene scroll 200 to the outer direction (that is, direction away from the central axis (CA) of the heating flow path 103) to support other portion that covers the one portion of the graphene scroll 200 from the outer direction.

For example, as illustrated in FIG. 6, the spacer 250 may be formed integrally with the graphene scroll 200. Particularly, the spacer 250 may be formed by bending a portion of the graphene scroll 200. A portion of the bent graphene scroll 200 may include a portion of the graphene layer 200a and a portion of the base layer 200b. Alternatively, the spacer 250 may be formed as a separate configuration from the graphene scroll 200 and may be coupled to the graphene scroll 200.

For example, as illustrated in FIG. 6, a plurality of spacers 250 may be provided. The plurality of spacers 250 may be arranged to be spaced apart from each other within the heating flow path 103.

The graphene scroll 200 may further include a support layer 220. The support layer 220 may form one outer surface of the graphene scroll 200. Particularly, the support layer 220 may be disposed on one surface of the graphene scroll 200 supported by the spacer 250. The spacer 250 may protrude from one portion of the graphene scroll 200, and the support layer 220 may be provided on other portion that covers the one portion of the graphene scroll 200. Accordingly, as the spacer 250 is in contact with the support layer 220, the spacer 250 may support other portion of the graphene scroll 200.

For example, the support layer 220 may be attached to one surface of the base layer 200b opposite to the graphene layer 200a. That is, the support layer 220 may be provided on one surface, which is opposite to the encapsulation layer (en), of the graphene scroll 200. For example, the support layer 220 may form one inner surface of the graphene scroll 200 (that is, one surface facing the central axis (CA) of the heating flow path 103).

The support layer 220 may be formed in a thin film shape.

For example, the support layer 220 may be formed of various materials, such as a resin material containing polyethylene terephthalate (PET) material.

As mentioned above, as the spacer 250 comes into contact with the support layer 220, the spacer 250 may support more stably other portion of the graphene scroll 200.

When describing the spacer 250 based on one spacer 250a among the plurality of spacers 250 shown in FIG. 6, the spacer 250a may be provided to form a separation space between the first portion 211 and the second portion 212 of the graphene scroll 200. For example, the spacer 250a may protrude from the first portion 211 of the graphene scroll 200 toward the second portion 212. In other words, the spacer 250a may protrude from the first portion 211 of the graphene scroll 200 to the direction away from the central axis (CA) of the heating flow path 103. As a result, the spacer 250a may support the second portion 212 of the graphene scroll 200 and maintain the separation space between the first portion 211 and the second portion 212 of the graphene scroll 200.

A portion 220a of the support layer 220 may be arranged on one surface, which faces the first portion 211, of the second portion 212 of the graphene scroll 200. At this time, the spacer 250a may protrude from the first portion 211 and be in contact with the support layer 220, thereby supporting the second portion 212.

Each spacer 250 disposed in the graphene scroll 200 may have characteristics corresponding to the spacer 250a described above.

Unlike FIG. 6, the graphene scroll 200 may not include a separate support layer 220, and in this case, the spacer 250 may be in direct contact with the base layer 200b of other portion of the graphene scroll 200.

Unlike FIG. 6, the spacer 250 may be disposed on one side of the graphene scroll 200 and may be formed as a configuration separated from the graphene scroll 200. For example, the spacer 250 may be disposed on one side of the encapsulation layer (en) of one portion of the graphene scroll 200 and may be formed in a shape that protrudes toward other portion covering the one portion. In this way, the spacer 250 formed on one side of the encapsulation layer (en) may include a material with high heat resistance. For example, the spacer 250 may be formed of various materials such as polyethylene terephthalate (PET).

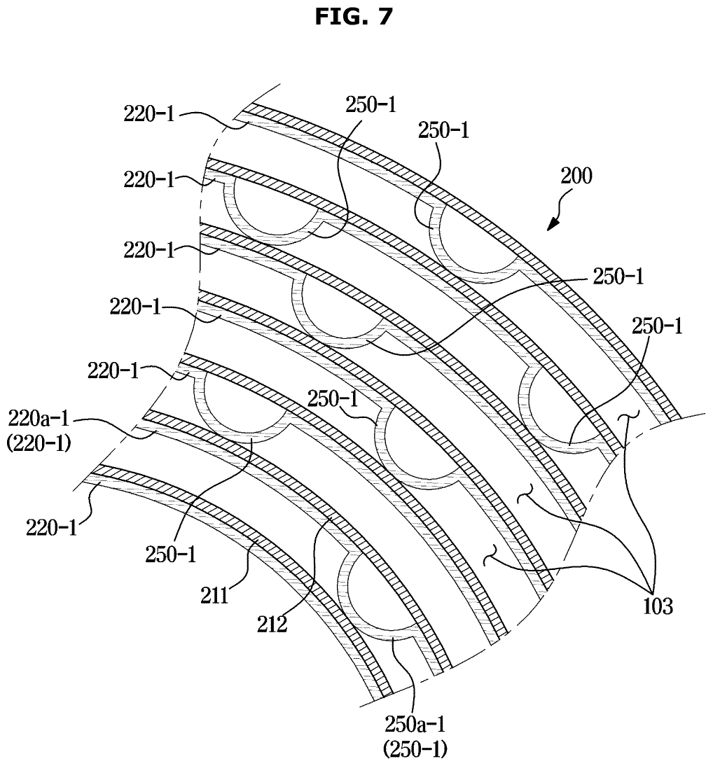

FIG. 7 is an enlarged view of a portion of the graphene scroll of the hot air blower according to an embodiment of the disclosure.

Referring to FIG. 7, the heater 100 according to an embodiment of the disclosure may further include a spacer 250-1. Similar to the spacer 250 of FIG. 6, the spacer 250-1 of FIG. 7 may be provided to form a separation space between one portion of the graphene scroll 200 and other portion covering the one portion from the outer direction. The spacer 250-1 may be provided to support one portion of the graphene scroll 200 or other portion covering the one portion from the outer direction. The spacer 250-1 may be disposed within the heating flow path 103.

For example, the spacer 250-1 may protrude from one portion of the graphene scroll 200 to the inner direction (that is, direction closer to the central axis (CA) of the heating flow path 103) so as to support other portion in which an outer side thereof is covered by the one portion of the graphene scroll 200.

For example, the graphene scroll 200 may include a support layer 220-1. Because the support layer 220-1 of FIG. 7 has characteristics corresponding to the support layer 220-1 of FIG. 6, a detailed description thereof will be omitted.

At this time, the spacer 250-1 may protrude from the support layer 220-1. Particularly, the spacer 250-1 may protrude from one portion of the support layer 220-1, which is provided on one portion of the graphene scroll 200, and be in contact with other portion of the graphene scroll 200.

For example, as illustrated in FIG. 7, the spacer 250-1 may be formed integrally with the graphene scroll 200. Particularly, the spacer 250-1 may be formed by bending a portion of the graphene scroll 200. As illustrated in FIG. 7, the spacer 250-1 may be formed integrally with the support layer 220-1 of the graphene scroll 200. The spacer 250-1 may be formed by bending a portion of the support layer 220-1.

The spacer 250-1 may be manufactured by bending the support layer 220-1 that is provided separately from the graphene layer 200a and the base layer 200b. Accordingly, it is possible to select the material of the support layer 220-1 from various materials that are easier to bend than the graphene layer 200a and the base layer 200b that the material is specified to some extent. Therefore, it is possible to more efficiently manufacture the spacer 250-1.

Unlike FIG. 7, the spacer 250-1 may include a portion of the graphene layer 200a and a portion of the base layer 200b.

Alternatively, the spacer 250-1 may be formed as a configuration separated from the graphene scroll 200 and may be coupled to the graphene scroll 200.

For example, as illustrated in FIG. 7, a plurality of spacers 250-1 may be provided. The plurality of spacers 250-1 may be arranged to be spaced apart from each other within the heating flow path 103.

When describing the spacer 250-1 based on one spacer 250a-1 among the plurality of spacers 250-1 shown in FIG. 7, the spacer 250a-1 may be provided to form a separation space between the first portion 211 and the second portion 212 of the graphene scroll 200. For example, the spacer 250a-1 may protrude from a portion 220a-1 of the support layer 220-1 provided in the second portion 212 of the graphene scroll 200 toward the first portion 211. In other words, the spacer 250a-1 may protrude from the one portion 220a-1 of the support layer 220-1 provided in the second portion 212 of the graphene scroll 200 to the direction closer to the central axis (CA) of the heating flow path 103. As a result, the spacer 250a-1 may support the first portion 211 of the graphene scroll 200 and maintain the separation space between the first portion 211 and the second portion 212 of the graphene scroll 200.

Each spacer 250-1 disposed in the graphene scroll 200 may have characteristics corresponding to the above-described spacer 250a-1.

Unlike FIG. 7, the graphene scroll 200 may not include a separate support layer 220-1, and in this case, the spacer 250-1 may be not formed by the support layer 220-1, but formed by directly bending a portion of the graphene layer 200a, a portion of the base layer 200b, and the like. Alternatively, the spacer 250-1 may be formed as a separate configuration and attached to one surface of the base layer 200b (that is, one surface of the base layer 200b opposite to the graphene layer 200a that is one inner surface).

With the configuration according to the embodiment of FIG. 6 or the embodiment of FIG. 7, the shape of the graphene scroll 200 may be prevented from being deformed, and the heating flow path 103 formed between each portion of the graphene scroll 200 may be maintained efficiently. Accordingly, an area in which the graphene scroll 200 is in contact with the heating flow path 103 may be increased, and the heating efficiency of air may be improved.

Unlike FIGS. 6 and 7, the graphene scroll 200 may not include a separate physical structure, such as the above-described spacer 250 (or 250-1), configured to prevent the deformation of the shape of the graphene scroll 200. For example, when the material of the adhesive layer (ad) or the encapsulation layer (en) included in the graphene scroll 200 is a material that hardens after a certain period of time (or when a certain process is performed) after coating, the graphene scroll 200 may maintain the shape thereof after the manufacturing of the graphene scroll 200 is completed.

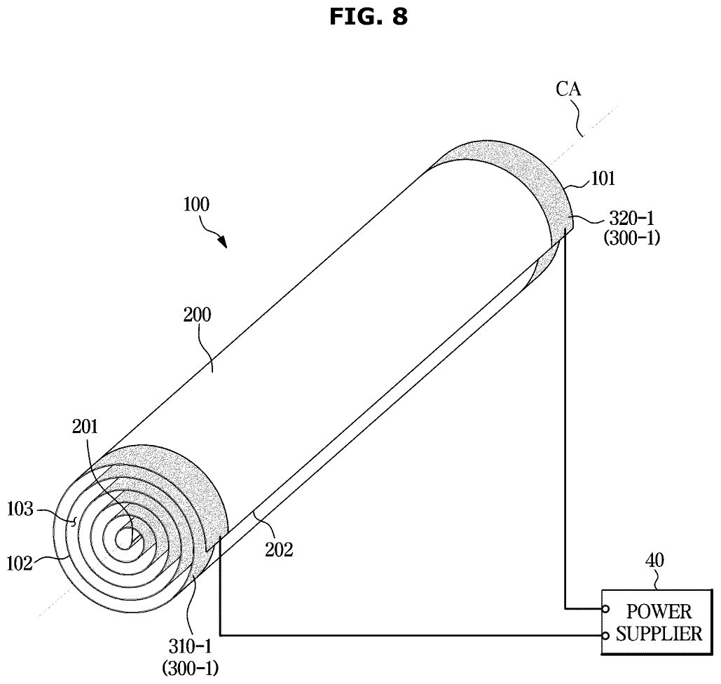

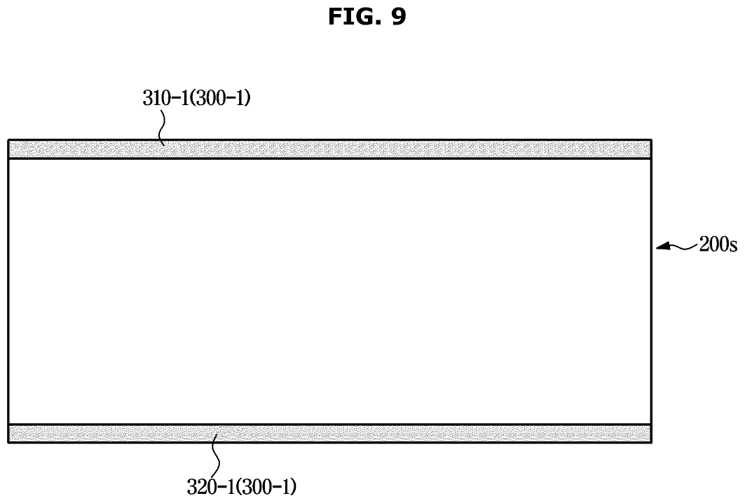

FIG. 8 is a view illustrating a heater included in a hot air blower according to an embodiment of the disclosure. FIG. 9 is a view illustrating a graphene sheet forming a graphene scroll of FIG. 8 and electrodes connected to the graphene sheet according to an embodiment of the disclosure.

When describing an embodiment of the disclosure with reference to FIGS. 8 and 9, the same components as the embodiments of FIGS. 1 to 7 may have the same reference numerals and descriptions thereof may be omitted.

Referring to FIGS. 8 and 9, a heater 100 included in the hot air blower 1 according to various embodiments of the disclosure may include a plurality of electrodes 300-1 configured to apply a voltage to a graphene scroll 200. The plurality of electrodes 300-1 may be in contact with the graphene scroll 200 and electrically connected to the graphene scroll 200. The plurality of electrodes 300-1 may be electrically connected to a power supplier 40. The plurality of electrodes 300-1 may be arranged to be spaced apart from each other. The power supplier 40 may be configured to apply a voltage between the plurality of electrodes 300-1.

Some of the plurality of electrodes 300-1 may be disposed adjacent to an inlet 101. Others of the plurality of electrodes 300-1 may be disposed adjacent to an outlet 102.

Particularly, the plurality of electrodes 300-1 may include a pair of counter electrodes 310-1 and 320-1. The pair of counter electrodes 310-1 and 320-1 may be arranged to face each other. A first side electrode 310-1 of the pair of counter electrodes 310-1 and 320-1 may be disposed adjacent to the outlet 102, and a second side electrode 320-1 of the pair of counter electrodes 310-1 and 320-1 opposite to the first side electrode 310-1 may be disposed adjacent to the inlet 101. The first side electrode 310-1 may be disposed to be spaced apart from the inlet 101, and the second side electrode 320-1 may be disposed to be spaced apart from the outlet 102.

A direction in which each of the plurality of electrodes 300-1 extends may be different from a direction in which a central axis (CA) of a heating flow path 103 extends. The plurality of electrodes 300-1 may be arranged in parallel to each other in the direction in which the inlet 101 and the outlet 102 face each other. The plurality of electrodes 300-1 may be arranged in parallel to each other in the direction in which the central axis (CA) of the heating flow path 103 extends.

Each of plurality of electrodes 300-1 may extend in a direction parallel to a direction extending from one end, which is adjacent to the central axis (CA) of the heating flow path 103, of the graphene scroll 200 toward the other end. In other words, each of the plurality of electrodes 300-1 may extend in a direction parallel to a direction in which the graphene scroll 200 extends from a first end 201 to a second end 202. That is, each of the plurality of electrodes 300-1 may extend in a first direction D1 from one end, which is adjacent to the central axis (CA) of the heating flow path 103, of opposite ends toward the other end. Each of the plurality of electrodes 300-1 may extend to allow a distance from the central axis (CA) of the heating flow path 103 to increase toward the first direction D1. Each of the plurality of electrodes 300-1 may be formed in a substantially scroll shape.

For example, as illustrated in FIG. 8, the first side electrode 310-1 of the pair of counter electrodes 310-1 and 320-1 may be disposed at one end, which is adjacent to the outlet 102, of the graphene scroll 200. The second side electrode 320-1 of the pair of counter electrodes 310-1 and 320-1 may be disposed at the other end, which is adjacent to the inlet 101, of the graphene scroll 200.

For example, when a graphene sheet 200s has a rectangular shape as illustrated in FIG. 9, each of the pair of counter electrodes 310-1 and 320-1 may extend parallel to a long side of a graphene sheet 200s. In this case, the central axis (CA) of the heating flow path 103 may be parallel to a short side of the graphene sheet 200s.

As illustrated in FIG. 9, each of the pair of counter electrodes 310 and 320 may extend in a direction parallel to the long side of the graphene sheet 200s, and the pair of counter electrodes 310 and 320 may face to each other with respect to the short side of the graphene sheet 200s. Further, the pair of counter electrodes 310 and 320 may be arranged at opposite ends of the graphene sheet 200s. When the pair of counter electrodes 310-1 and 320-1 extend in the direction parallel to the long side of the graphene sheet 200s, a distance between the pair of counter electrodes 310-1 and 320-1 may be reduced in comparison with a case in which the pair of counter electrodes 310-1 and 320-1 extend in the direction parallel to the short side of the graphene sheet 200s. When the distance between the pair of counter electrodes 310-1 and 320-1 is reduced, an intensity of current flowing through the graphene scroll 200 may increase, which causes the increase in the amount of heat generation.

However, according to the shape of the graphene sheet 200s, the central axis (CA) of the heating flow path 103 may be parallel to the short side of the graphene sheet 200s, and in this case, the pair of counter electrodes 310-1 and 320-1 may extend in a direction parallel to the short side of the graphene sheet 200s. Alternatively, the graphene sheet 200s may have a substantially square shape.

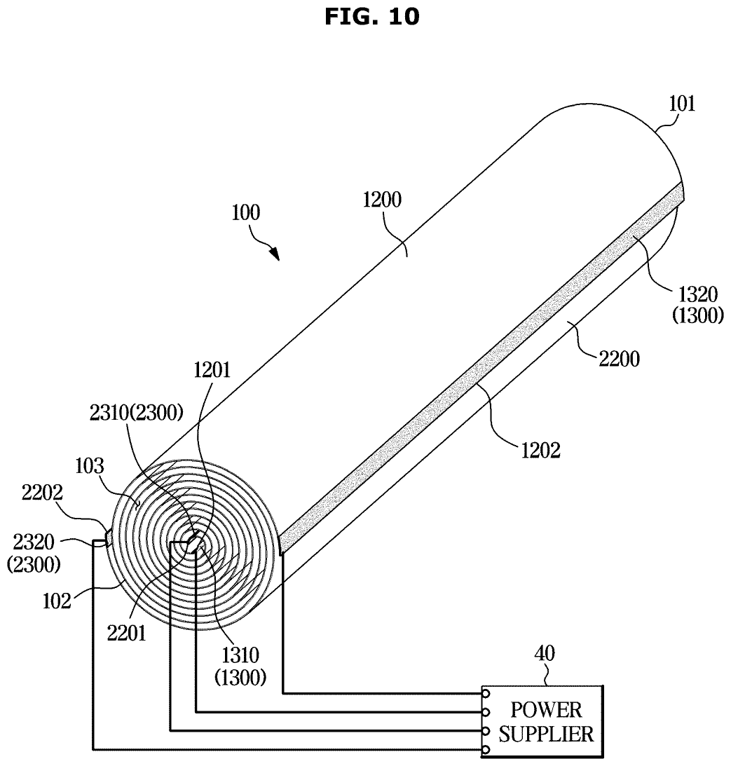

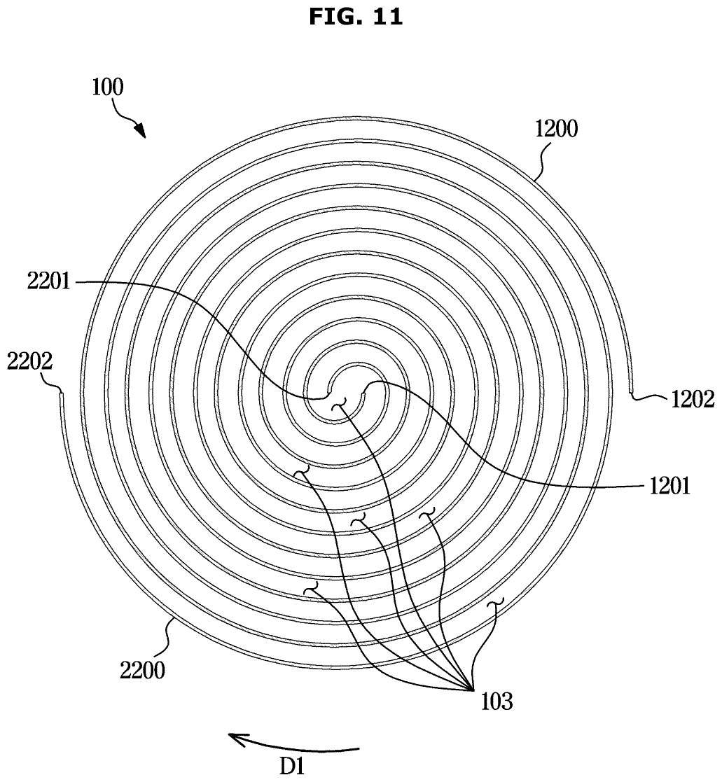

FIG. 10 is a view illustrating a heater included in a hot air blower, particularly illustrating the heater including a plurality of graphene scrolls according to an embodiment of the disclosure. FIG. 11 is a cross-sectional view illustrating the plurality of graphene scrolls of the heater of FIG. 10 according to an embodiment of the disclosure.

When describing an embodiment of the disclosure with reference to FIGS. 10 and 11, the same components as the embodiments of FIGS. 1 to 5 may have the same reference numerals and descriptions thereof may be omitted.

Referring to FIGS. 10 and 11, a heater 100 included in a hot air blower 1 according to various embodiments of the disclosure may include a first graphene scroll 1200 and a second graphene scroll 2200. The first graphene scroll 1200 and the second graphene scroll 2200 may each be configured to generate heat when a current flows. The first graphene scroll 1200 and the second graphene scroll 2200 may each be configured to heat air flowing by a fan 21. The first graphene scroll 1200 and the second graphene scroll 2200 may each be configured to heat air within a heating flow path 103.

The first graphene scroll 1200 and the second graphene scroll 2200 may each form the heating flow path 103 extending between an inlet 101 and an outlet 102. Each of the first graphene scroll 1200 and the second graphene scroll 2200 may have a shape corresponding to the graphene scroll 200 according to the embodiment of FIGS. 1 to 5.

The first graphene scroll 1200 may extend to allow a distance from a central axis of the heating flow path 103 to increase from a first end 1201 adjacent to the central axis of the heating flow path 103 toward a second end 1202 opposite thereto. As illustrated in FIG. 11, the first graphene scroll 1200 may extend in a first direction D1 from the first end 1201 toward the second end 1202.

The second graphene scroll 2200 may extend to allow a distance, which is from the central axis of the heating flow path 103, to increase from a first end 2201 adjacent to the central axis of the heating flow path 103 toward the second end 1202 opposite thereto. As illustrated in FIG. 11, the second graphene scroll 2200 may extend in the first direction D1 from the first end 2201 toward a second end 2202.

Based on FIG. 11, the first direction D1 is counterclockwise, but is not limited thereto, and the first direction D1 may be clockwise based on FIG. 11.

The first graphene scroll 1200 and the second graphene scroll 2200 may be spaced apart from each other. The heating flow path 103 may be formed between the first graphene scroll 1200 and the second graphene scroll 2200. That is, at least a portion of the heating flow path 103 may be formed in a separation space between the first graphene scroll 1200 and the second graphene scroll 2200.

In addition, the first graphene scroll 1200 and the second graphene scroll 2200 may be arranged to overlap each other. At least a portion of the first graphene scroll 1200 may cover at least a portion of the second graphene scroll 2200 from an outer direction. At least a portion of the second graphene scroll 2200 may cover at least a portion of the first graphene scroll 1200 from an outer direction. The outer direction means a direction toward the outside of the heater 100 and a direction away from the central axis of the heating flow path 103. In this way, a portion of the first graphene scroll 1200 may be arranged to cover a portion of the second graphene scroll 2200, and a portion of the second graphene scroll 2200 may be arranged to cover a portion of the first graphene scroll 1200. Accordingly, the first graphene scroll 1200 and the second graphene scroll 2200 may be arranged to overlap each other at positions spaced apart from each other. In other words, the first graphene scroll 1200 and the second graphene scroll 2200 may be arranged to surround each other.

As mentioned above, the heater 100 according to an embodiment of the disclosure may increase a heat generation area per volume by including the plurality of graphene scrolls 1200 and 2200 that are spaced apart from each other and overlap each other.

The heater 100 may include a plurality of first electrodes 1300 configured to apply a voltage to the first graphene scroll 1200. Each of the plurality of first electrodes 1300 may be electrically connected to a power supplier 40. The power supplier 40 may be configured to apply a voltage between the plurality of first electrodes 1300. When a voltage is applied between the plurality of first electrodes 1300, the first graphene scroll 1200 may generate heat. The plurality of first electrodes 1300 may have characteristics corresponding to the plurality of electrodes 300 according to the embodiment of FIGS. 1 to 5.

Each of the plurality of first electrodes 1300 may extend in a direction parallel to each other. For example, as illustrated in FIG. 10, each of the plurality of electrodes 1300 may extend in a direction parallel to a direction in which the heating flow path 103 extends. Particularly, each of the plurality of electrodes 1300 may extend in a direction parallel to a direction in which the heating flow path 103 extends from the inlet 101 toward the outlet 102. Each of the plurality of electrodes 1300 may extend in a direction substantially parallel to the central axis of the heating flow path 103.

For example, as illustrated in FIG. 10, the plurality of first electrodes 1300 may include a pair of first counter electrodes 1310 and 1320.

For example, as illustrated in FIG. 10, one electrode 1310 of the pair of first counter electrodes 1310 and 1320 may extend along the first end 1201 of the first graphene scroll 1200. The one electrode 1310 of the pair of first counter electrodes 1310 and 1320 may come into contact with the first end 1201 of the first graphene scroll 1200 and may be spaced apart from the second end 1202.

For example, as illustrated in FIG. 10, the other 1320 of the pair of first counter electrodes 1310 and 1320 may extend along the second end 1202 of the first graphene scroll 1200. The other 1320 of the pair of first counter electrodes 1310 and 1320 may come into contact with the second end 1202 of the first graphene scroll 1200 and may be spaced apart from the first end 1201.

The heater 100 may include a plurality of second electrodes 2300 configured to apply a voltage to the second graphene scroll 2200. Each of the plurality of second electrodes 2300 may be electrically connected to the power supplier 40. The power supplier 40 may be configured to apply a voltage between the plurality of second electrodes 2300. When a voltage is applied between the plurality of second electrodes 2300, the second graphene scroll 2200 may generate heat. The plurality of second electrodes 2300 may have characteristics corresponding to the plurality of electrodes 300 according to the embodiments of FIGS. 1 to 5.

Each of the plurality of second electrodes 2300 may extend in a direction parallel to each other. For example, as illustrated in FIG. 10, each of the plurality of electrodes 2300 may extend in a direction parallel to the direction in which the heating flow path 103 extends. Particularly, each of the plurality of electrodes 2300 may extend in a direction parallel to the direction in which the heating flow path 103 extends from the inlet 101 toward the outlet 102. Each of the plurality of electrodes 2300 may extend in a direction substantially parallel to the central axis of the heating flow path 103.

For example, as illustrated in FIG. 10, the plurality of second electrodes 2300 may include a pair of second counter electrodes 2310 and 2320.

For example, as illustrated in FIG. 10, one electrode 2310 of the pair of second counter electrodes 2310 and 2320 may extend along the first end 2201 of the second graphene scroll 2200. The one electrode 2310 of the pair of second counter electrodes 2310 and 2320 may come into contact with the first end 2201 of the second graphene scroll 2200 and may be spaced apart from the second end 2202.

For example, as illustrated in FIG. 10, the other 2320 of the pair of second counter electrodes 2310 and 2320 may extend along the second end 2202 of the second graphene scroll 2200. The other 2320 of the pair of second counter electrodes 2310 and 2320 may come into contact with the second end 2202 of the second graphene scroll 2200 and may be spaced apart from the first end 2201.

For example, the plurality of first electrodes 1300 and the plurality of second electrodes 2300 may extend in a direction parallel to each other.

The plurality of first electrodes 1300 and the plurality of second electrodes 2300 may be arranged spaced apart from each other.

The power supplier 40 may be configured to apply a voltage between the plurality of first electrodes 1300, or apply a voltage between the plurality of second electrodes 2300, or simultaneously apply a voltage between the plurality of first electrodes 1300 and a voltage between the plurality of second electrodes 2300.

For example, the plurality of first electrodes 1300 and the plurality of second electrodes 2300 may be connected to one power supplier 40, and the controller 50 may selectively control the on/off of a switch of a circuit including the plurality of first electrodes 1300, the plurality of second electrodes 2300, and the power supplier 40. Accordingly, the voltage may be applied between the plurality of first electrodes 1300, or the voltage may be applied between the plurality of second electrodes 2300, or the voltage may be applied between the plurality of first electrodes 1300 and the voltage may be applied between the plurality of second electrodes 2300.

Alternatively, the power supplier 40 may be composed of a plurality of separate modules. For example, the power supplier 40 may be composed of a power supplier that applies a voltage between the plurality of first electrodes 1300 and a power supplier that applies a voltage between the plurality of second electrodes 2300, and the controller 50 may be configured to individually control each power supplier.

With this configuration, heat may be generated in the first graphene scroll 1200, in the second graphene scroll 2200, or simultaneously in each of the first graphene scroll 1200 and the second graphene scroll 2200. Compared to heat being generated only in the first graphene scroll 1200 or heat being generated only in the second graphene scroll 2200, when heat is generated simultaneously in each of the first graphene scroll 1200 and the second graphene scroll 2200, the amount of heat generation may increase.

Accordingly, at least one power supplier 40 may apply a voltage between the plurality of first electrodes 1300 or apply a voltage between the plurality of second electrodes 2300 based on a first condition. In other words, the controller 50 may control the at least one power supplier 40 to allow a voltage to be applied between the plurality of first electrodes 1300 or to allow a voltage to be applied between the plurality of second electrodes 2300 based on the first condition. In other words, the controller 50 may control the at least one power supplier 40 to allow heat to be generated in the first graphene scroll 1200 or to allow heat to be generated in the second graphene scroll 2200 based on the first condition.

In addition, at least one power supplier 40 may apply a voltage between the plurality of first electrodes 1300 and apply a voltage between the plurality of second electrodes 2300 based on a second condition. In other words, the controller 50 may control the at least one power supplier 40 to allow a voltage to be applied between the plurality of first electrodes 1300 and to allow a voltage to be applied between the plurality of second electrodes 2300 based on the second condition. In other words, the controller 50 may control the at least one power supplier 40 to allow heat to be generated in each of the first graphene scroll 1200 and the second graphene scroll 2200 based on the second condition.

When a condition for heating air at a first temperature is referred to as the first condition, a condition for heating air at a second temperature higher than the first temperature may be referred to as the second condition.

For example, the first condition and the second condition may each be satisfied based on a user input obtained through the input device 30. That is, the controller 50 may control at least one power supplier 40 to apply a voltage between the plurality of first electrodes 1300 or to apply a voltage between the plurality of second electrodes 2300 based on a user input obtained through the input device 30 to heat air at the first temperature. In addition, the controller 50 may control at least one power supplier 40 to apply a voltage between the plurality of first electrodes 1300 and to apply a voltage between the plurality of second electrodes 2300 based on a user input obtained through the input device 30 to heat air at the second temperature higher than the first temperature.

With this configuration, the heater 100 may heat the air at several temperatures.

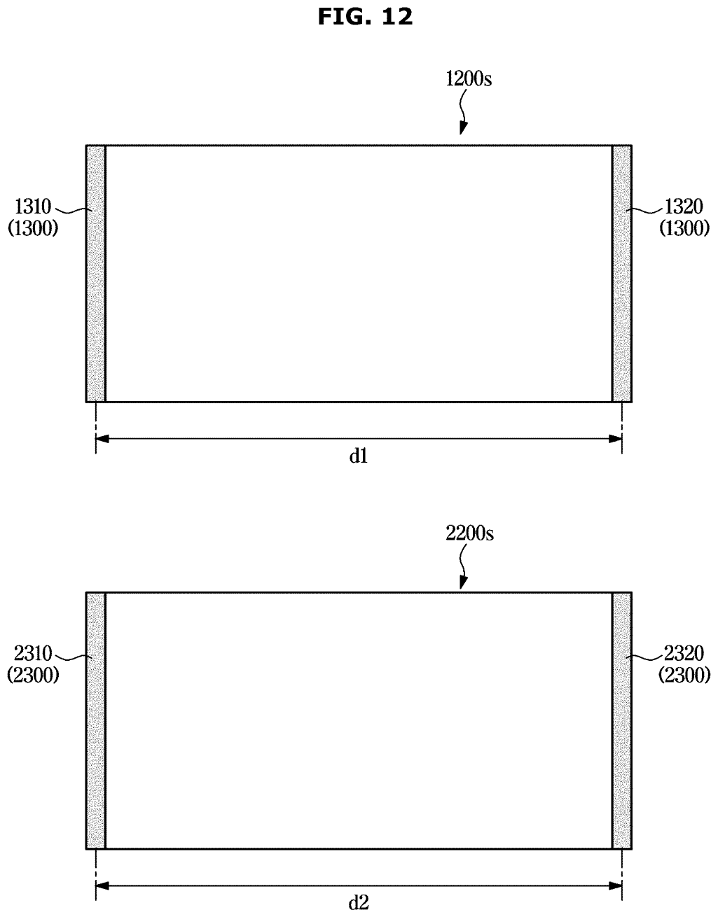

FIG. 12 is a view illustrating graphene sheets each forming the plurality of graphene scrolls included in the hot air blower, and electrodes each connected to the graphene sheets according to an embodiment of the disclosure.

A first graphene sheet 1200s having a shape, in which the first graphene scroll 1200 is flatly unfolded, and the pair of first electrodes 1310 and 1320 coupled thereto, and a second graphene sheet 2200s having a shape, in which the second graphene scroll 2200 is flatly unfolded, and the pair of second electrodes 2310 and 2320 coupled thereto, which are provided in the heater 100 of the hot air blower 1 according to an embodiment of the disclosure, are compared and described with reference to FIG. 12

A structure and characteristics of the first graphene sheet 1200s in the embodiment shown in FIG. 12 correspond to the structure and characteristics of the graphene sheet 200s according to the embodiment shown in FIG. 5. A structure and characteristics of the second graphene sheet 2200s in the embodiment shown in FIG. 12 correspond to the structure and characteristics of the graphene sheet 200s according to the embodiment shown in FIG. 5.

Referring to FIG. 12, a distance d1 between the pair of first electrodes 1310 and 1320 coupled to the first graphene sheet 1200s and a distance d2 between the pair of second electrodes 2310 and 2320 coupled to the second graphene sheet 2200s may be substantially equal to each other.

In this case, in a state in which a heat generation density of the first graphene scroll 1200 and a heat generation density of the second graphene scroll 2200 are almost the same, a heat generation amount of the first graphene scroll 1200 when a voltage is applied between the pair of first electrodes 1310 and 1320 and a heat generation amount of the second graphene scroll 2200 when a voltage is applied between the pair of second electrodes 2310 and 2320 may be substantially equal to each other.

Accordingly, in this case, at least one power supplier 40 may apply a voltage between the plurality of first electrodes 1300 or apply a voltage between the plurality of second electrodes 2300 based on a first condition. In other words, the controller 50 may control the at least one power supplier 40 to generate heat in one of the first graphene scroll 1200 or the second graphene scroll 2200 based on the first condition. In addition, the at least one power supplier 40 may apply a voltage between the plurality of first electrodes 1300 and apply a voltage between the plurality of second electrodes 2300 based on a second condition. In other words, the controller 50 may control the at least one power supplier 40 to generate heat in each of the first graphene scroll 1200 and the second graphene scroll 2200 based on the second condition.

The first condition may be a condition for heating air at a first temperature, and the second condition may be a condition for heating air at a second temperature higher than the first temperature.

Alternatively, in a state in which the heat generation density of the first graphene scroll 1200 and the heat generation density of the second graphene scroll 2200 are different from each other, the heat generation amount of the first graphene scroll 1200 when a voltage is applied between the pair of first electrodes 1310 and 1320 and the heat generation amount of the second graphene scroll 2200 when a voltage is applied between the pair of second electrodes 2310 and 2320 may be different from each other.

For example, in a state in which it is assumed that the heat generation density of the first graphene scroll 1200 is less than the heat generation density of the second graphene scroll 2200, the heat generation amount of the first graphene scroll 1200 when a voltage is applied between the pair of first electrodes 1310 and 1320 may be less than the heat generation amount of the second graphene scroll 2200 when a voltage is applied between the pair of second electrodes 2310 and 2320.

In this case, at least one power supplier 40 may apply a voltage between the plurality of first electrodes 1300 based on a first condition. In other words, the controller 50 may control the at least one power supplier 40 to generate heat in the first graphene scroll 1200 based on the first condition. In addition, the at least one power supplier 40 may apply a voltage between the plurality of second electrodes 2300 based on a second condition. In other words, the controller 50 may control the at least one power supplier 40 to generate heat in the second graphene scroll 2200 based on the second condition. In addition, the at least one power supplier 40 may apply a voltage between the plurality of first electrodes 1300 and apply a voltage between the plurality of second electrodes 2300 based on a third condition. In other words, the controller 50 may control the at least one power supplier 40 to generate heat in each of the first graphene scroll 1200 and the second graphene scroll 2200 based on the third condition.

The first condition may be a condition for heating air at a first temperature, the second condition may be a condition for heating air at a second temperature higher than the first temperature, and the third condition may be a condition for heating air at a third temperature higher than the second temperature.

With this configuration, the heater 100 may heat the air at several temperatures.

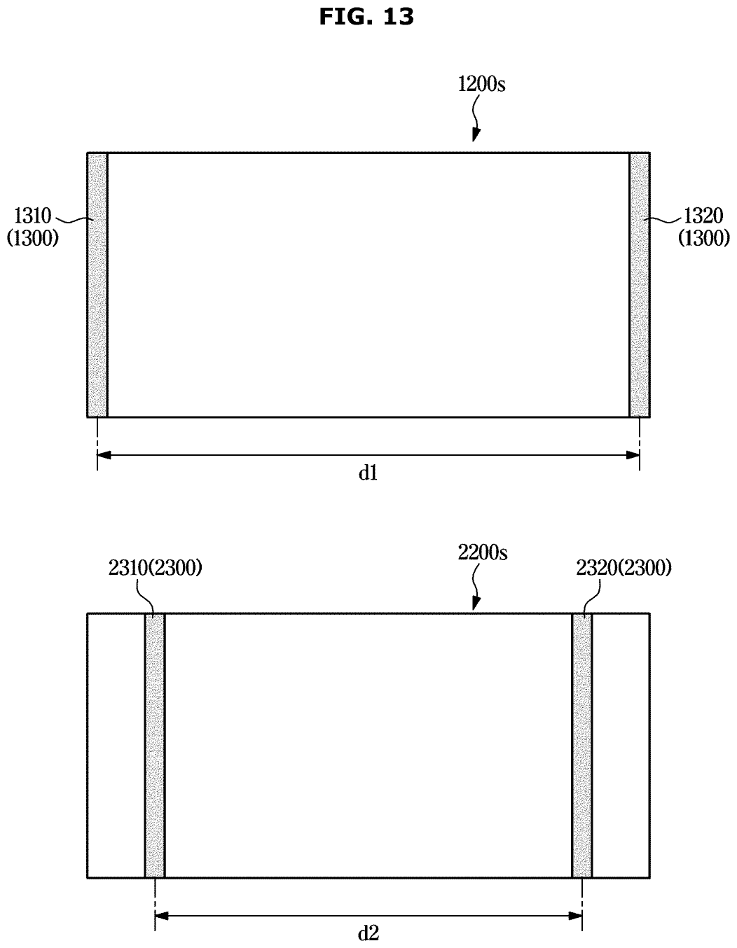

FIG. 13 is a view illustrating graphene sheets each forming the plurality of graphene scrolls included in the hot air blower, and electrodes each connected to the graphene sheets according to an embodiment of the disclosure.

A first graphene sheet 1200s having a shape, in which the first graphene scroll 1200 is flatly unfolded, and the pair of first electrodes 1310 and 1320 coupled thereto, and a second graphene sheet 2200s having a shape, in which the second graphene scroll 2200 is flatly unfolded, and the pair of second electrodes 2310 and 2320 coupled thereto, which are provided in the heater 100 of the hot air blower 1 according to an embodiment of the disclosure, are compared and described with reference to FIG. 13.

A structure and characteristics of the first graphene sheet 1200s in the embodiment illustrated in FIG. 13 correspond to the structure and characteristics of the graphene sheet 200s according to the embodiment shown in FIG. 5. A structure and characteristics of the second graphene sheet 2200s in the embodiment shown in FIG. 13 correspond to the structure and characteristics of the graphene sheet 200s according to the embodiment illustrated in FIG. 5.

Referring to FIG. 13, a distance d1 between the pair of first electrodes 1310 and 1320 coupled to the first graphene sheet 1200s and a distance d2 between the pair of second electrodes 2310 and 2320 coupled to the second graphene sheet 2200s may be different from each other, which is different from the embodiment of FIG. 12.

In this case, even when a heat generation density of the first graphene scroll 1200 and a heat generation density of the second graphene scroll 2200 are almost the same, a heat generation amount of the first graphene scroll 1200 when a voltage is applied between the pair of first electrodes 1310 and 1320 and a heat generation amount of the second graphene scroll 2200 when a voltage is applied between the pair of second electrodes 2310 and 2320 may be different from each other.

For example, when it is assumed that the distance d2 between the pair of second electrodes 2310 and 2320 coupled to the second graphene sheet 2200s is less than the distance d1 between the pair of first electrodes 1310 and 1320 coupled to the first graphene sheet 1200s, and that the heat generation density of the first graphene scroll 1200 and the heat generation density of the second graphene scroll 2200 are almost the same, a heat generation area of the first graphene scroll 1200 may be greater than a heat generation area of the second graphene scroll 2200. Therefore, the heat generation of the first graphene scroll 1200 when a voltage is applied between the pair of first electrodes 1310 and 1320 may be greater than the heat generation of the second graphene scroll 2200 when a voltage is applied between the pair of second electrodes 2310 and 2320.

In this case, the controller 50 may control at least one power supplier 40 to apply a voltage between the plurality of second electrodes 2300 based on a first condition. In other words, the controller 50 may control the at least one power supplier 40 to generate heat in the second graphene scroll 2200 based on the first condition. In addition, the at least one power supplier 40 may apply a voltage between the plurality of first electrodes 1300 based on a second condition. In other words, the controller 50 may control the at least one power supplier 40 to generate heat in the first graphene scroll 1200 based on the second condition. In addition, the at least one power supplier 40 may apply a voltage between the plurality of first electrodes 1300 and apply a voltage between the plurality of second electrodes 2300 based on a third condition. In other words, the controller 50 may control the at least one power supplier 40 to generate heat in each of the first graphene scroll 1200 and the second graphene scroll 2200 based on the third condition.

The first condition may be a condition for heating air at a first temperature, the second condition may be a condition for heating air at a second temperature higher than the first temperature, and the third condition may be a condition for heating air at a third temperature higher than the second temperature.

For example, the first condition, the second condition, and the third condition may be satisfied based on a user input for heating air at a specific temperature being obtained through the input device 30.

With this configuration, the heater 100 may heat the air at several temperatures.

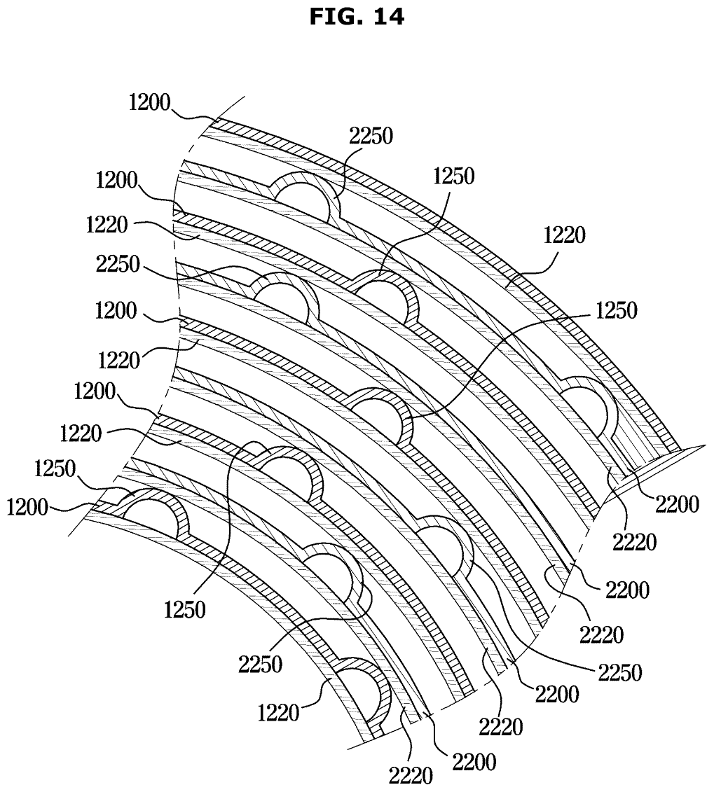

FIG. 14 is an enlarged view of a portion of the plurality of graphene scrolls included in the hot air blower according to an embodiment of the disclosure.

Referring to FIG. 14, the heater 100 according to an embodiment of the disclosure may further include spacers 1250 and 2250. The spacers 1250 and 2250 may be provided between the first graphene scroll 1200 and the second graphene scroll 2200. The spacers 1250 and 2250 may be provided to maintain a separation space between the first graphene scroll 1200 and the second graphene scroll 2250. The spacers 1250 and 2250 may be disposed within the heating flow path 103.

Particularly, the hot air blower 1 may include a first spacer 1250 protruding from the first graphene scroll 1200. The first spacer 1250 may be provided to maintain a separation space formed between a portion of the first graphene scroll 1200 and a portion of the second graphene scroll 2200 that covers a portion of the first graphene scroll 1200 from an outer direction. The first spacer 1250 may protrude from a portion of the first graphene scroll 1200 from the outer direction and may come into contact with a portion of the second graphene scroll 2200 that covers a portion of the first graphene scroll 1200 from the outer direction.

For example, the first spacer 1250 may be formed integrally with the first graphene scroll 1200. Particularly, the first spacer 1250 may be formed by bending a portion of the first graphene scroll 1200. Alternatively, the first spacer 1250 may be formed as a separate configuration from the first graphene scroll 1200 and then coupled to the first graphene scroll 1200.

For example, a plurality of first spacers 1250 may be provided. The plurality of first spacers 1250 may be arranged spaced apart from each other within the heating flow path 103.

The heater 100 may include a second spacer 2250 protruding from the second graphene scroll 2200. The second spacer 2250 may be provided to maintain a separation space formed between a portion of the second graphene scroll 2200 and a portion of the first graphene scroll 1200 that covers a portion of the second graphene scroll 2200 from the outer direction. The second spacer 2250 may protrude from the portion of the second graphene scroll 2200 to the outer direction and may come into contact with a portion of the first graphene scroll 1200 that covers a portion of the second graphene scroll 2200 from the outer direction.

For example, the second spacer 2250 may be formed integrally with the second graphene scroll 2200. Particularly, the second spacer 2250 may be formed by bending a portion of the second graphene scroll 2200. Alternatively, the second spacer 2250 may be formed as a separate configuration from the second graphene scroll 2200 and then coupled to the second graphene scroll 2200.

For example, a plurality of second spacers 2250 may be provided. The plurality of second spacers 2250 may be arranged spaced apart from each other within the heating flow path 103.

For example, the first graphene scroll 1200 may further include a first support layer 1220. The first support layer 1220 may form one outer surface of the first graphene scroll 1200. Particularly, the first support layer 1220 may be provided on one surface of the first graphene scroll 1200 supported by the second spacer 2250. The second spacer 2250 may protrude from a portion of the second graphene scroll 2200, and the first support layer 1220 may be provided on a portion of the first graphene scroll 1200 that covers an upper portion of the second graphene scroll 2200. Accordingly, the second spacer 2250 may support a portion of the first graphene scroll 1200 by coming into contact with the first support layer 1220.

However, unlike FIG. 14, the first graphene scroll 1200 may not include a separate first support layer 1220, and in this case, the second spacer 2250 may be in direct contact with a portion of the base layer (refer to the embodiment of FIG. 5) of the first graphene scroll 1200.

For example, the second graphene scroll 2200 may further include a second support layer 2220. The second support layer 2220 may form one outer surface of the second graphene scroll 2200. Particularly, the second support layer 2220 may be provided on one surface of the second graphene scroll 2200 supported by the first spacer 1250. The first spacer 1250 may protrude from a portion of the first graphene scroll 1200, and the second support layer 2220 may be provided on a portion of the second graphene scroll 2200 that covers an upper portion of the first graphene scroll 1200. Accordingly, the first spacer 1250 may support a portion of the second graphene scroll 2200 by coming into contact with the second support layer 2220.

However, unlike FIG. 14, the second graphene scroll 2200 may not include a separate second support layer 2220, and in this case, the first spacer 1250 may be in direct contact with a portion of the base layer (refer to the embodiment of FIG. 5) of the second graphene scroll 2200.

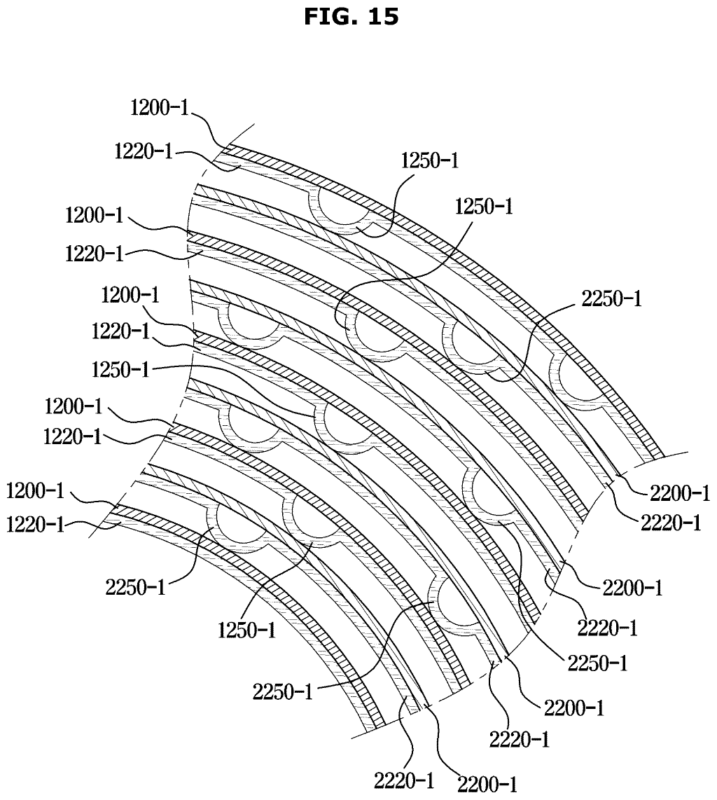

FIG. 15 is an enlarged view of a portion of a plurality of graphene scrolls included in a hot air blower according to an embodiment of the disclosure.

Referring to FIG. 15, a heater 100 according to an embodiment of the disclosure may further include spacers 1250-1 and 2250-1. The spacers 1250-1 and 2250-1 may be provided between a first graphene scroll 1200-1 and a second graphene scroll 2200-1, which is similar to the spacers 1250 and 2250 of FIG. 14. The spacers 1250-1 and 2250-1 may be provided to maintain a separation space between the first graphene scroll 1200-1 and the second graphene scroll 2250-1. The spacer 1250-1 and 2250-1 may be disposed within the heating flow path 103.

Particularly, a hot air blower 1 may include a first spacer 1250-1 protruding from the first graphene scroll 1200-1. The first spacer 1250-1 may be provided to maintain a separation space formed between one portion of the first graphene scroll 1200-1 and a portion of the second graphene scroll 2200-1 in which an outer side thereof is covered by the one portion of the first graphene scroll 1200-1. The first spacer 1250-1 may protrude inwardly from one portion of the first graphene scroll 1200-1 and may come into contact with one portion of the second graphene scroll 2200-1 in which an outer side thereof is covered by the one portion of the first graphene scroll 1200-1.

For example, the first graphene scroll 1200-1 may include a first support layer 1220-1. At this time, the first spacer 1250-1 may protrude from the first support layer 1220-1. Particularly, the first spacer 1250-1 may protrude from a portion of the first support layer 1220-1 provided on a portion of the first graphene scroll 1200-1 and may come into contact with a portion of the second graphene scroll 2200-1.

For example, the first spacer 1250-1 may be formed integrally with the first graphene scroll 1200-1. Particularly, the first spacer 1250-1 may be formed by bending a portion of the first graphene scroll 1200-1. Referring to FIG. 15, the first spacer 1250-1 may be formed integrally with the first support layer 1220-1 of the first graphene scroll 1200-1. The first spacer 1250-1 may be formed by bending a portion of the first support layer 1220-1.

Alternatively, the first spacer 1250-1 may include a portion of the graphene layer (refer to the embodiment of FIG. 5) of the first graphene scroll 1200-1, and a portion of the base layer (refer to the embodiment of FIG. 5).

Alternatively, the first spacer 1250-1 may be formed as a separate configuration from the first graphene scroll 1200-1 and coupled to the first graphene scroll 1200-1.

For example, a plurality of the first spacers 1250-1 may be provided. The plurality of first spacers 1250-1 may be arranged spaced apart from each other within the heating flow path 103.

The hot air blower 1 may include a second spacer 2250-1 protruding from the second graphene scroll 2200-1. The second spacer 2250-1 may be provided to maintain a separation space formed between one portion of the second graphene scroll 2200-1 and one portion of the first graphene scroll 1200-1 in which an outer side thereof is covered by the one portion of the second graphene scroll 2200-1. The second spacer 2250-1 may protrude inwardly from one portion of the second graphene scroll 2200-1 and may come into contact with one portion of the first graphene scroll 1200-1 in which an outer side thereof is covered by the one portion of the second graphene scroll 2200-1.

For example, the second graphene scroll 2200-1 may include a second support layer 2220-1. At this time, the second spacer 2250-1 may protrude from the second support layer 2220-1. Particularly, the second spacer 2250-1 may protrude from a portion of the second support layer 2220-1 provided on a portion of the second graphene scroll 2200-1 and may come into contact with a portion of the first graphene scroll 1200-1.

For example, the second spacer 2250-1 may be formed integrally with the second graphene scroll 2200-1. Particularly, the second spacer 2250-1 may be formed by bending a portion of the second graphene scroll 2200-1. As illustrated in FIG. 15, the second spacer 2250-1 may be formed integrally with the second support layer 2220-1 of the second graphene scroll 2200-1. The second spacer 2250-1 may be formed by bending a portion of the second support layer 2220-1.

Alternatively, the second spacer 2250-1 may include a portion of the graphene layer (refer to the embodiment of FIG. 5) of the second graphene scroll 2200-1 and a portion of the base layer (refer to the embodiment of FIG. 5).

Alternatively, the second spacer 2250-1 may be formed as a separate configuration from the second graphene scroll 2200-1 and coupled to the second graphene scroll 2200-1.

For example, a plurality of second spacers 2250-1 may be provided. The plurality of second spacers 2250-1 may be arranged spaced apart from each other within the heating flow path 103.

The first graphene scroll 1200 and the second graphene scroll 2200 may not include a separate physical structure, such as the above-described first spacer 1250 (or 1250-1) and second spacer 2250 (or 2250-1), configured to prevent the shape of the first graphene scroll 1200 and the second graphene scroll 2200 from being deformed, which is different from the description described with reference to FIGS. 14 and 15. For example, when the material of the adhesive layer (refer to the embodiment of FIG. 5) or the encapsulation layer (refer to the embodiment of FIG. 5) included in the first graphene scroll 1200 and the second graphene scroll 2200 is composed of a material that hardens after a certain period of time (or when a certain process is performed) after coating, each of the first graphene scroll 1200 and the second graphene scroll 2200 may maintain a shape thereof by itself after manufacturing is completed.

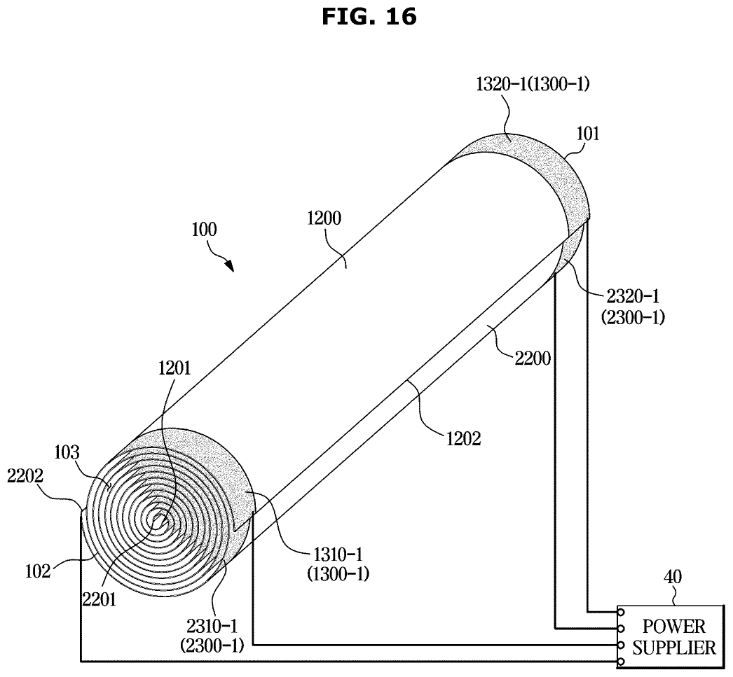

FIG. 16 is a view illustrating a heater, which is included in a hot air blower, including a plurality of graphene scrolls according to an embodiment of the disclosure.

When describing an embodiment of the disclosure with reference to FIG. 16, the same components as the embodiments of FIGS. 10 to 15 may have the same reference numerals and descriptions thereof may be omitted.

Referring to FIG. 16, a heater 100 included in a hot air blower 1 according to an embodiment of the disclosure may include a plurality of first electrodes 1300-1 configured to apply a voltage to a first graphene scroll 1200, and a plurality of second electrodes 2300-1 configured to apply a voltage to a second graphene scroll 2200.

A plurality of first electrodes 1300-1 may come into contact with the first graphene scroll 1200 and may be electrically connected to the first graphene scroll 1200. A power supplier 40 may be configured to apply a voltage between the plurality of first electrodes 1300-1. When a voltage is applied between the plurality of first electrodes 1300-1, the first graphene scroll 1200 may generate heat.

Some of the plurality of first electrodes 1300-1 may be positioned adjacent to an inlet 101. Others of the plurality of first electrodes 1300-1 may be positioned adjacent to an outlet 102. The plurality of first electrodes 1300-1 may be positioned spaced apart from each other.

Particularly, the plurality of first electrodes 1300-1 may include a pair of first counter electrodes 1310-1 and 1320-1. The pair of first counter electrodes 1310-1 and 1320-1 may be arranged to face each other. One electrode 1310-1 of the pair of first counter electrodes 1310-1 and 1320-1 may be arranged adjacent to the outlet 102, and the other electrode 1320-1 of the pair of first counter electrodes 1310-1 and 1320-1 may be arranged adjacent to the inlet 101.

A direction in which the plurality of first electrodes 1300-1 extends may be different from a direction in which a central axis of the heating flow path 103 extends. The plurality of first electrodes 1300-1 may be arranged parallel to each other in a direction in which the inlet 101 and the outlet 102 face each other. The plurality of first electrodes 1300-1 may be arranged parallel to each other in the direction in which the central axis of the heating flow path 103 extends.

Each of the plurality of first electrodes 1300-1 may extend in a direction parallel to the direction extending from a first end 1201, which is adjacent to the central axis of the heating flow path 103, of the first graphene scroll 1200 toward a second end 1202 opposite thereto. That is, each of the plurality of first electrodes 1300-1 may extend to allow a distance from the central axis of the heating flow path 103 to increase from the first end 1201 toward the second end 1202. Each of the plurality of first electrodes 1300-1 may be formed in a substantially scroll shape.

For example, as illustrated in FIG. 16, one electrode 1310-1 of the pair of first counter electrodes 1310-1 and 1320-1 may be provided at one end, which is adjacent to the outlet 102, of the first graphene scroll 1200. The other electrode 1320-1 of the pair of first counter electrodes 1310-1 and 1320-1 may be provided at the other end, which is adjacent to the inlet 101, of the first graphene scroll 1200.

A plurality of second electrodes 2300-1 may come into contact with the second graphene scroll 2200 and may be electrically connected to the second graphene scroll 2200. A power supplier 40 may be configured to apply a voltage between the plurality of second electrodes 2300-1. When a voltage is applied between the plurality of second electrodes 2300-1, the second graphene scroll 2200-1 may generate heat.

Some of the plurality of second electrodes 2300-1 may be positioned adjacent to the inlet 101. Others of the plurality of second electrodes 2300-1 may be positioned adjacent to the outlet 102. The plurality of second electrodes 2300-1 may be positioned spaced apart from each other.

Particularly, the plurality of second electrodes 2300-1 may include a pair of second counter electrodes 2310-1 and 2320-1. The pair of second counter electrodes 2310-1 and 2320-1 may be arranged to face each other. One electrode 2310-1 of the pair of second counter electrodes 2310-1 and 2320-1 may be arranged adjacent to the outlet 102, and the other electrode 2320-1 of the pair of second counter electrodes 2310-1 and 2320-1 may be arranged adjacent to the inlet 101.

A direction in which the plurality of second electrodes 2300-1 extends may be different from the direction in which the central axis of the heating flow path 103 extends. The plurality of second electrodes 2300-1 may be arranged parallel to each other in the direction in which the inlet 101 and the outlet 102 face each other. The plurality of second electrodes 2300-1 may be arranged parallel to each other in the direction in which the central axis of the heating flow path 103 extends.

Each of the plurality of second electrodes 2300-1 may extend in a direction parallel to the direction extending from the first end 2201, which is adjacent to the central axis of the heating flow path 103, of the second graphene scroll 2200 toward the second end 2202 opposite thereto. That is, each of the plurality of second electrodes 2300-1 may extend to allow a distance from the central axis of the heating flow path 103 to increase from the first end 2201 toward the second end 2202. Each of the plurality of second electrodes 2300-1 may be formed in a substantially scroll shape.

For example, as illustrated in FIG. 16, one electrode 2310-1 of the pair of second counter electrodes 2310-1 and 2320-1 may be provided at one end of the second graphene scroll 2200 adjacent to the outlet 102. The other electrode 2320-1 of the pair of second counter electrodes 2310-1 and 2320-1 may be provided at the other end of the second graphene scroll 2200 adjacent to the inlet 101.

The power supplier 40 may apply a voltage to between the plurality of first electrodes 1300-1, apply a voltage to between the plurality of second electrodes 2300-1, or apply a voltage between the plurality of first electrodes 1300-1 and also apply a voltage between the plurality of second electrodes 2300-1, which is similar to the description described with reference to FIGS. 10 to 13. In other words, the controller 50 may control the power supplier 40 to allow heat to be generated in the first graphene scroll 1200, control the power supplier 40 to allow heat to be generated in the second graphene scroll 2200, or control the power supplier 40 to allow heat to be generated simultaneously in each of the first graphene scroll 1200 and the second graphene scroll 2200. At this time, conditions for generating heat by applying a voltage to the first graphene scroll 1200 or for generating heat by applying a voltage to the second graphene scroll 2200 may be based on a user input corresponding to a temperature, to which air is to be heated, which is described above, and a detailed description thereof will be omitted.

In addition, the temperature at which the air is to be heated may vary depending on the difference in the distance between the pair of first counter electrodes 1310-1 and 1320-1 and the distance between the pair of second counter electrodes 2310-1 and 2320-1, and the difference in the heat generation density of the first graphene scroll 1200 and the second graphene scroll 2200, as described above with reference to FIGS. 10 to 13, and a detailed description thereof will be omitted.

FIG. 17 is a cross-sectional view illustrating a portion of a hot air blower according to an embodiment of the disclosure.

Referring to FIG. 17, a heater 100-2 of a hot air blower 1 according to an embodiment of the disclosure may include an inlet 101-2 through which air flows into the heater 100-2, and an outlet 102-2 through which air is discharged from the heater 100-2. A heating flow path 103-2 in which air is heated may be formed between the inlet 101-2 and the outlet 102-2. Air may flow along the heating flow path 103-2.

The heater 100-2 may include at least one graphene scroll 200-2. The heating flow path 103-2 may be formed by the at least one graphene scroll 200-2. The at least one graphene scroll 200-2 may be configured to heat air flowing along the heating flow path 103-2. The at least one graphene scroll 200-2 may be configured to generate heat based on a voltage being applied.

Referring to FIGS. 3 to 9, the graphene scroll 200-2 may be a single graphene scroll composed of a single graphene sheet. Alternatively, referring to FIGS. 10 to 16, the graphene scroll 200-2 may be composed of a plurality of graphene sheets and may include a plurality of graphene scrolls arranged to overlap each other.

Referring to FIG. 17, a width r2 of the outlet 102-2 of the heater 100-2 may be less than a width r1 of the inlet 101-2. In other words, a cross-sectional area of the outlet 102-2 may be less than a cross-sectional area of the inlet 101-2.

Accordingly, a cross-sectional area of one side of the heating flow path 103-2 adjacent to the outlet 102-2 may be less than a cross-sectional area of the other side of the heating flow path 103-2 adjacent to the inlet 101-2. As illustrated in FIG. 17, the heating flow path 103-2 may be formed to have a width that is reduced from the inlet 101-2 toward the outlet 102-2.

Referring to FIG. 17, a width of the heating flow path 103-2 may decrease at a constant rate from the inlet 101-2 toward the outlet 102-2, but is not limited thereto.

In other words, the graphene scroll 200-2 may be formed to allow a cross-sectional area of the heating flow path 103-2 on a side adjacent to the outlet 102-2 to be less than a cross-sectional area of the heating flow path 103-2 on a side adjacent to the inlet 101-2.

The width of the heating flow path 103-2, the width r1 of the inlet 101-2, and the width r2 of the outlet 102-2 refer to a width measured in a direction perpendicular to a central axis (CA) of the heating flow path 103-2.

In addition, the cross-sectional area of the heating flow path 103-2, the cross-sectional area of the inlet 101-2, and the cross-sectional area of the outlet 102-2 refer to an area of a cross section that is cut into a plane perpendicular to the central axis (CA) of the heating flow path 103-2.

With this configuration, a flow rate of the air flowing in through the outlet 102-2 may be greater than a flow rate of the air flowing in through the inlet 101-2, and thus the hot air blower 1 may provide hot air at a faster rate

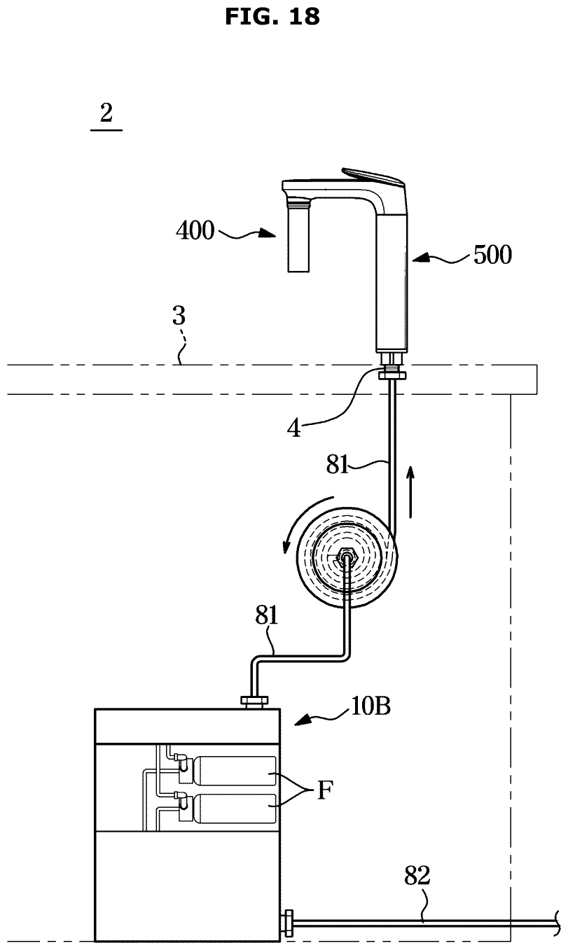

FIG. 18 is a view schematically illustrating a water purifier according to an embodiment of the disclosure.

Referring to FIG. 18, a water purifier 2 according to an embodiment of the disclosure may include a filtering body 10B and a dispenser 500 configured to provide a liquid to an outside of the filtering body 10B.

For example, the filtering body 10B may be disposed in a lower portion of a kitchen work table 3. For example, the filtering body 10B may be disposed inside the kitchen work table 3.

For example, the dispenser 500 may be disposed in an upper portion of the kitchen work table 3. According to an embodiment, the dispenser 500 may be rotatably provided on the upper portion of the kitchen work table 3.

For example, an installation member 4 for installing the dispenser 500 may be provided on the kitchen work table 3. The installation member 4 may be formed by opening at least a portion of the kitchen work table 3. For example, the installation member 4 may be formed by opening the upper portion of the kitchen work table 3. The dispenser 500 may be rotatably installed on the installation member 4. The installation member 4 may include various structures configured to allow the dispenser 500 to be installed on the kitchen work table 3.

For example, the kitchen work table 3 may include a sink table. The sink table may include a sink and a kitchen countertop.

The filtering body 10B may be configured to generate purified water by filtering raw water. The filtering body 10B may be configured to generate purified water and deliver the purified water to the dispenser 500.

Particularly, the filtering body 10B may be connected to an external pipe 82 connected to an external water supply source. The filtering body 10B may be connected to the external water supply source through the external pipe 82, and may receive raw water such as tap water from the external water supply source through the external pipe 82. The filtering body 10B may generate purified water by filtering raw water supplied through the external pipe 82.

The filtering body 10B may include at least one filter (F). The filter (F) may be configured to filter raw water to produce purified water. The filter (F) may be configured to separate impurities contained in raw water and generate purified water.

For example, the filter (F) may include a pre-carbon filter configured to adsorb volatile substances such as chlorine and chlorine by-products from raw water, a membrane filter configured to filter out very small contaminants by reverse osmosis, and a post-carbon filter configured to affect taste of purified water that is discharged. At this time, as for the filter (F), the pre-carbon filter, the membrane filter, and the post-carbon filter may be sequentially connected, and the raw water flowing into the filter (F) may be purified by sequentially passing through the pre-carbon filter, the membrane filter, and the post-carbon filter.

In addition, the filter (F) may include various types of filters. Additionally, the plurality of filters (F) may be arranged in the sequence different from the sequence described above.

The dispenser 500 may be configured to discharge the liquid delivered from the filtering body 10B. For example, the dispenser 500 may provide purified water. The dispenser 500 may be provided to receive purified water generated from the filtering body 10B and discharge the purified water to the outside. The dispenser 500 may be configured to discharge purified water, which passes through the filter (F), to the outside. The dispenser 500 may be disposed downstream of a flow path from the filter (F).

The dispenser 500 may be connected to the filtering body 10B. The dispenser 500 may be connected to the filtering body 10B and receive purified water from the filtering body 10B.

The water purifier 2 may include a connection pipe 81 connecting the filtering body 10B and the dispenser 500. One side of the connection pipe 81 may be connected to the filtering body 10B and the other side of the connection pipe 81 may be connected to the dispenser 500. The dispenser 500 may be connected to the filtering body 10B through the connection pipe 81. A flow path, through which purified water flows from the filtering body 10B, may be arranged inside the connection pipe 81. Purified water generated in the filtering body 10B may flow to the dispenser 500 through the connection pipe 81.

For example, the dispenser 500 may be connected to the connection pipe 81 through the installation member 4 of the kitchen work table 3. The dispenser 500 may be configured to be movable relative to the kitchen work table 3 and/or the filtering body 10B.

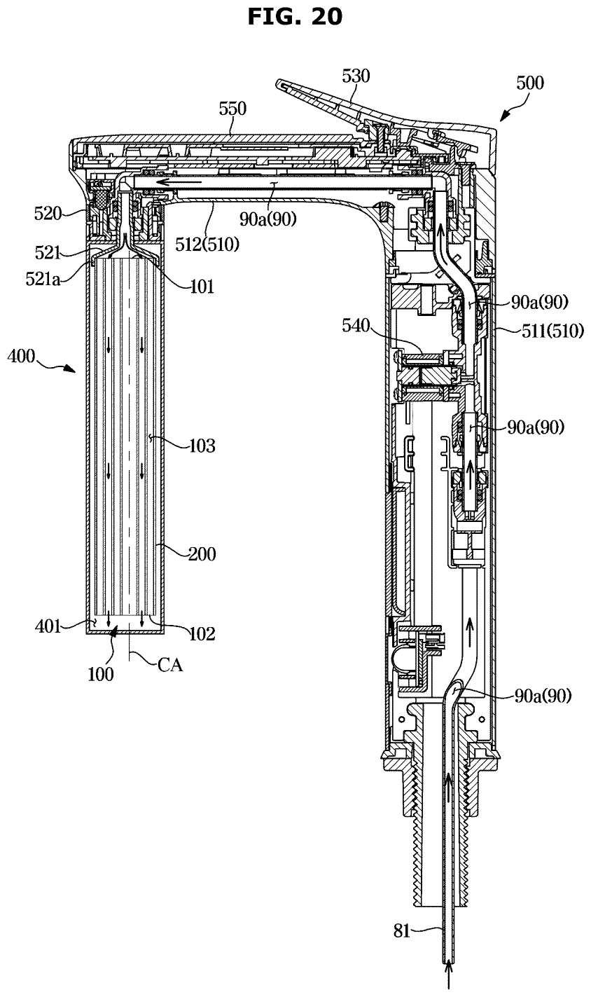

The water purifier 2 may include a filtering flow path 90 (refer to FIG. 20). The filtering flow path 90 may include a flow path through which raw water is filtered to generate purified water. The filtering flow path 90 may include a flow path through which purified water flows.

For example, a portion of the filtering flow path 90 may be disposed inside the filtering body 10B. For example, a portion of the filtering flow path 90 may be disposed inside the connection pipe 81. For example, a portion of the filtering flow path 90 may be disposed inside the dispenser 500.

Purified water flowing through the filtering flow path 90 may be discharged to the outside through the dispenser 500.

The configuration of the water purifier 2 described above with reference to FIG. 18 is only an example of the configuration of the water purifier according to the disclosure. The disclosure is not limited thereto, and the water purifier 2 may include various configurations for providing purified water.

Unlike FIG. 18, the water purifier 2 may be used without being installed on the kitchen work table 3. For example, the water purifier 2 may be an independent device in which the dispenser 500 and the filtering body 10B are mounted in a single water purifier case.

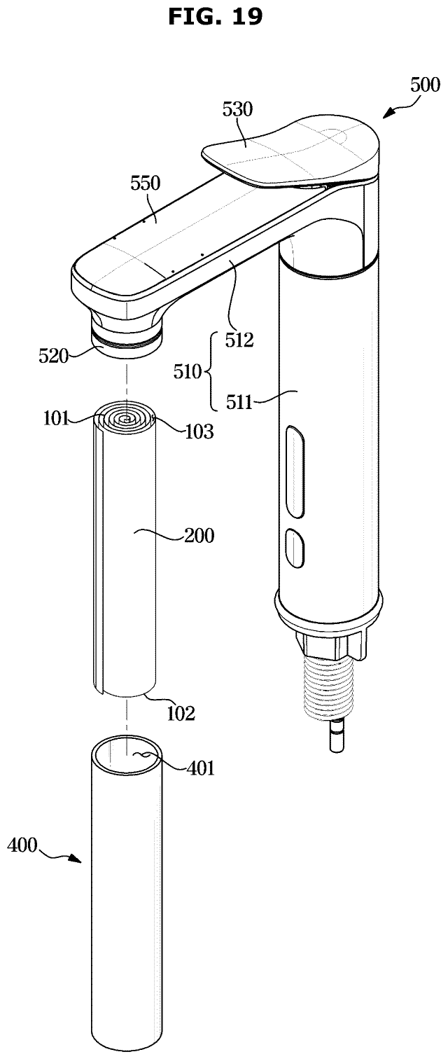

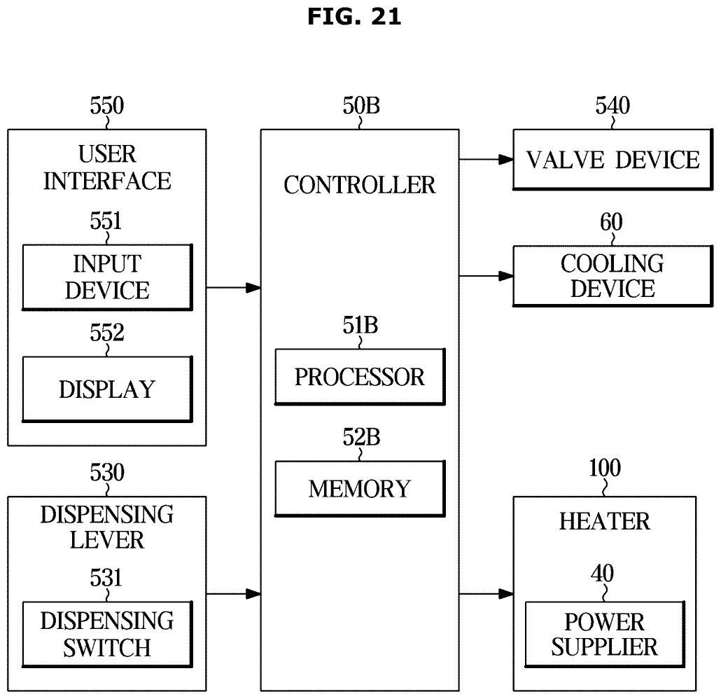

FIG. 19 is a view illustrating a dispenser and a heater of the water purifier according to an embodiment of the disclosure. FIG. 20 is a cross-sectional view illustrating the dispenser and the heater of the water purifier according to an embodiment of the disclosure. FIG. 21 is a block diagram illustrating some components of the water purifier according to an embodiment of the disclosure.

Referring to FIGS. 19 to 21, the dispenser 500 of the water purifier 2 according to various embodiments of the disclosure may include a dispenser body 510 forming an exterior of the dispenser 500. Various components of the dispenser 500 may be disposed in the dispenser body 510.

For example, as illustrated in FIG. 18, one side of the dispenser body 510 may be mounted on the kitchen work table 3. For example, the dispenser body 510 may be rotatably mounted on the kitchen work table 3.

For example, the dispenser body 510 may include a neck 511 extending in a substantially vertical direction and a head 512 extending in a substantially horizontal direction from an upper portion of the neck 511. A lower portion of the neck 511 may be mounted on the kitchen work table 3. The neck 511 may have a shape that stands substantially upward from the kitchen work table 3. Alternatively, the neck 511 may be disposed to be inclined with respect to one surface of the kitchen work table 3 on which the installation member 4 is formed.

For example, the neck 511 and the head 512 may be formed as separate pieces and then coupled to each other. Alternatively, the neck 511 and the head 512 may be formed integrally with each other.

The dispenser body 510 may be connected to the connection pipe 81. A portion of the connection pipe 81 may be disposed inside the dispenser body 510. A portion of the filtering flow path 90 through which purified water flows may be disposed inside the dispenser body 510.

The filtering flow path 90 may include a dispensing flow path 90a disposed inside the dispenser body 510. The dispensing flow path 90a may be disposed in a portion of the connection pipe 81 disposed inside the dispenser body 510.

The dispenser 500 may include a water outlet 520 provided to discharge a liquid from the dispenser 500. The water outlet 520 may be provided to discharge a liquid flowing along the dispensing flow path 90a. The water outlet 520 may be provided to discharge purified water flowing along the dispensing flow path 90a.

For example, the water outlet 520 may be disposed on the other side of the dispenser body 510 that is opposite to one side mounted on the kitchen work table 3. One side of the dispensing flow path 90a through which purified water is discharged may be disposed in the water outlet 520.

The dispenser 500 may include a nozzle 521. The nozzle 521 may be provided to discharge a liquid from the dispenser 500. The nozzle 521 may be provided to discharge a liquid flowing along the dispensing flow path 90a. The nozzle 521 may be provided to discharge purified water flowing along the dispensing flow path 90a.

Particularly, the nozzle 521 may be connected to the dispenser body 510. The nozzle 521 may be connected to the connection pipe 81 disposed inside the dispenser body 510. The nozzle 521 may be connected to the dispensing flow path 90a. That is, the nozzle 521 may be connected to the filtering flow path 90. The filtering flow path 90 may extend from the inside of the filtering body 10B to the nozzle 521.

For example, the nozzle 521 may be connected to the dispensing flow path 90a through the water outlet 520.

For example, the nozzle 521 may be mounted on the water outlet 520. Further, the nozzle 521 may be removably mounted on the water outlet 520. Alternatively, the nozzle 521 may be formed integrally with the water outlet 520.

The nozzle 521 may be provided in such a way that purified water flows into one side thereof connected to the dispensing flow path 90a and the purified water is discharged through the other side thereof opposite to the one side. That is, the nozzle 521 may form a discharge port through which purified water of the dispenser 500 is discharged.

For example, the nozzle 521 may be provided to discharge purified water downward.

The dispenser 500 may include a valve device 540 configured to allow or block the flow of liquid. The valve device 540 may control whether a liquid is discharged through the nozzle 521. For example, the valve device 540 may be configured to open and close the dispensing flow path 90a. The valve device 540 may be disposed on the dispensing flow path 90a.

For example, the valve device 540 may be disposed inside the dispenser body 510. For example, as illustrated in FIG. 20, the valve device 540 may be disposed inside the neck 511.

However, the disclosure is not limited thereto, and the valve device 540 may be disposed in various positions to allow or block the flow of purified water by opening or closing the filtering flow path 90.

The dispenser 500 may include a dispensing lever 530 configured to control the valve device 540. The dispensing lever 530 may control the discharge of liquid through the nozzle 521 by controlling the valve device 540.

The dispenser 500 may include a user interface 550. For example, the user interface 550 may receive a touch input. In addition, the user interface 550 may output an image.

Referring to FIGS. 19 and 20, the user interface 550 may be disposed on an upper surface of the dispenser 500. For example, the user interface 550 may be disposed on the head 512.

Particularly, the head 512 may be formed with an upper portion that is open. At this time, the user interface 550 may be coupled to the open upper portion of the head 512, and various electronic components forming the user interface 550 may be disposed in an internal space of the head 512.

However, the location of the user interface 550 is not limited to the example described above, and the user interface 550 may be disposed in various locations in which settings for discharging liquid is input from a user.

A detail of the user interface 550 will be described later.

The water purifier 2 may be configured to provide purified water at various temperatures. Particularly, the water purifier 2 may be configured to provide purified water of various temperatures based on a user input corresponding to temperature setting of the purified water.

For example, the water purifier 2 may include a cooling device 60. The cooling device 60 may be configured to cool a liquid. The cooling device 60 may be configured to cool purified water or raw water according to a location of the cooling device 60.

For example, the cooling device 60 may include a cooling circuit including a compressor, a condenser, an expander, and an evaporator. For example, the cooling device 60 may be disposed in the filtering body 10B. However, the disclosure is not limited thereto, and the cooling device 60 may include various types of cooling devices and may be disposed at various locations in the water purifier 2.

Further, the water purifier 2 may include a heater 100. The heater 100 may be configured to heat a liquid. The heater 100 may be configured to heat water. By the heater 100, the water purifier 2 may provide hot water.

The heater 100 may be configured to generate heat. The heater 100 may be configured to heat water by generating heat. The heater 100 may be configured to generate heat based on a voltage being applied.

The heater 100 may be disposed on a flow path, through which water flows, in the water purifier 2. The heater 100 may be configured to heat water passing through the heater 100.

Particularly, the heater 100 may include an inlet 101 through which water flows into the heater 100, and an outlet 102 through which water is discharged from the heater 100. Water may flow into the heater 100 through the inlet 101, be heated, and then be discharged from the heater 100 through the outlet 102.

The inlet 101 may be disposed on one side of the heater 100. The inlet 101 may be disposed on an upstream side of the heater 100. For example, as illustrated in FIGS. 19 and 20, the inlet 101 may be disposed on one side, which is adjacent to the nozzle 521, of the heater 100.

The outlet 102 may be disposed on the other side opposite to the one side in which the inlet 101 of the heater 100 is located. The outlet 102 may be disposed on a downstream side of the heater 100. For example, as illustrated in FIGS. 19 and 20, the outlet 102 may be disposed on the other side of the heater 100 opposite to the nozzle 521. The outlet 102 may be located in a downstream direction of the flow path from the inlet 101.

For example, a width of the inlet 101 may substantially correspond to a width of the outlet 102. In other words, a cross-sectional area of the inlet 101 may substantially correspond to a cross-sectional area of the outlet 102.

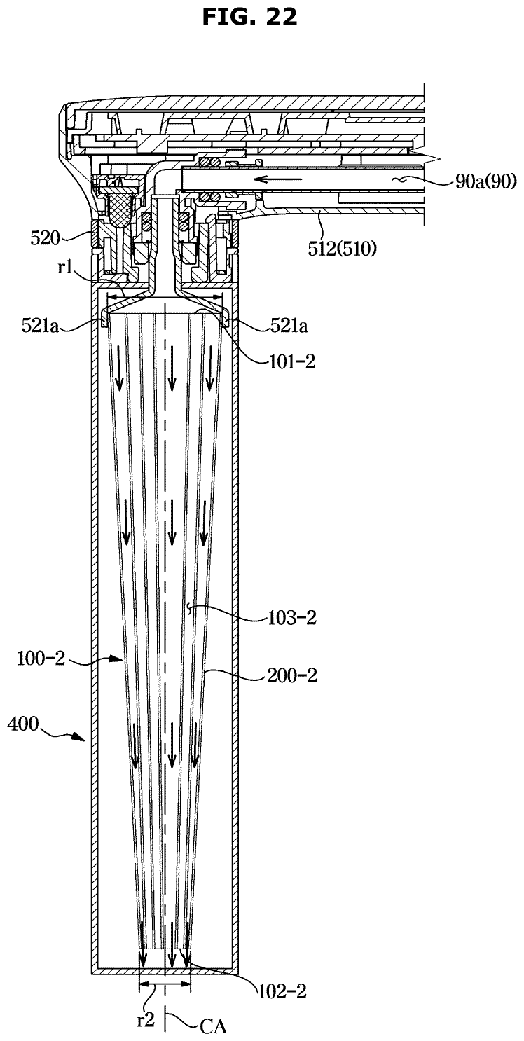

Alternatively, the width of the inlet 101 may be different from the width of the outlet 102. For example, the width of the inlet 101 may be greater or less than the width of the outlet 102 (for example, refer to FIG. 22).

The heater 100 may be formed to have a bar shape extending in one direction. For example, the heater 100 may extend linearly between the inlet 101 and the outlet 102 along a direction in which the inlet 101 and the outlet 102 face each other. However, the disclosure is not limited thereto, and the heater 100 may extend to have a shape in which at least a portion is curved between the inlet 101 and the outlet 102.

The heater 100 may include a graphene scroll 200 forming a heating flow path 103. The graphene scroll 200 may heat water flowing along the heating flow path 103 when a current flows. The graphene scroll 200 may be a single graphene scroll composed of a single graphene sheet, or may include a plurality of graphene scrolls composed of a plurality of graphene sheets and arranged to overlap each other.

The heating flow path 103 may form at least a portion of the flow path, through which water flows, in the water purifier 2. When water is provided by the water purifier 2, the water may pass through the heating flow path 103, and the graphene scroll 200 may heat the water passing through the heating flow path 103.

For example, the heating flow path 103 may extend in one direction, but is not limited thereto. The direction, in which the heating flow path 103 extends, may vary according to the shape of the heater 100, and the positions of the inlet 101 and the outlet 102.

The heater 100 may be connected to the filtering flow path 90. The heating flow path 103 may be connected to the filtering flow path 90. Accordingly, the water purifier 2 may provide heated purified water.

For example, the heater 100 may be configured to heat purified water. The heater 100 may be disposed downstream from the filtering flow path 90 to heat purified water. The heating flow path 103 may be disposed downstream from the filtering flow path 90. The heating flow path 103 may be disposed downstream from the dispensing flow path 90a. The inlet 101 of the heater 100 may be disposed downstream from the filtering flow path 90.

As illustrated in FIGS. 19 and 20, the heater 100 may be mounted on the dispenser 500. Particularly, the heater 100 may be mounted on the water outlet 520 of the dispenser 500. Alternatively, the heater 100 may be mounted on the nozzle 521 of the dispenser 500. The heater 100 may be disposed downstream from the nozzle 521 to heat purified water that is discharged from the nozzle 521. The inlet 101 of the heater 100 may be disposed downstream from the nozzle 521, and thus purified water discharged through the nozzle 521 may flow into the heater 100 through the inlet 101.

For example, the heater 100 may be arranged to extend in the vertical direction when mounted on the nozzle 521. In other words, as illustrated in FIGS. 19 and 20, when the heater 100 is mounted on the nozzle 521, the inlet 101 may be disposed on the upper side, the outlet 102 may be disposed on the lower side, and the heating flow path 103 may be arranged to extend in the vertical direction between the inlet 101 and the outlet 102. Accordingly, purified water discharged downward through the nozzle 521 may be heated while flowing downward along the heating flow path 103, and the heated purified water may be discharged downward through the outlet 102.

The nozzle 521 may include a heater mounting portion 521a on which the heater 100 is mounted. For example, the heater mounting portion 521a may be provided to support one side of the heater 100 adjacent to the inlet 101. For example, the heater mounting portion 521a may be provided to support an outer surface of the heater 100. For example, the nozzle 521 may be removably mounted on the heater mounting portion 521a.

As illustrated in FIGS. 19 and 20, the water purifier 2 may include a heater housing 400 in which the heater 100 is received. The heater housing 400 may cover an outer circumferential surface of the heater 100. The heater 100 may be configured to heat water flowing within the heater housing 400.

For example, when the heater 100 is mounted on the dispenser 500, the heater housing 400 may also be mounted on the dispenser 500. For example, when the heater 100 is mounted on the water outlet 520 or the nozzle 521, the heater housing 400 may also be mounted on the water outlet 520. For example, the heater housing 400 may be removably mounted on the water outlet 520.

The heater housing 400 may include a heater receiving portion 401 in which the heater 100 is received. The heater 100 may be disposed inside the heater receiving portion 401.

The heater housing 400 may be formed in such a way that opposite ends thereof are open. The heater receiving portion 401 may be connected to the outside of the heater receiving portion 401 through the open opposite ends.

Purified water discharged through the nozzle 521 may flow into the heater receiving portion 401 through one end of the heater housing 400, and purified water heated by the heater 100 may be discharged from the heater receiving portion 401 through the other end of the heater housing 400.

For example, the heater housing 400 may have a substantially cylindrical shape with a hollow, but the shape of the heater housing 400 is not limited thereto.

For example, the heater housing 400 may extend in the substantially vertical direction. Correspondingly, the heater receiving portion 401 may extend in the substantially vertical direction. The heater housing 400 and the heater 100 may extend in parallel directions.

For example, the heater housing 400 may be formed in such a way that an inner circumferential surface thereof comes into contact with an outermost circumference of the graphene scroll 200 of the heater 100, to support the graphene scroll 200 from the outside so as to maintain the shape of the graphene scroll 200. Alternatively, the inner circumferential surface of the heater housing 400 and the outermost circumference of the graphene scroll 200 may be spaced apart from each other.

Unlike the above description, the heater 100 may not be directly mounted on the nozzle 521. For example, the heater 100 may be supported by the heater housing 400 and mounted on the water outlet 520 through a structure, in which the heater housing 400 is mounted on the water outlet 520, and then connected to the nozzle 521. For example, the heater housing 400 may be removably mounted on the water outlet 520, and the heater 100 may be removably mounted on the heater housing 400. Alternatively, the heater 100 may be removably mounted directly on the water outlet 520.

Unlike the above description, the heater 100 may be provided in such a way that the heater 100 is not separated from the dispenser 500 after the heater 100 is mounted on the dispenser 500.

In the above, an embodiment, in which the heater 100 is disposed downstream from the filtering flow path 90 and directly heats purified water, is described. However, the arrangement of the heater 100 is not limited thereto. For example, the heater 100 may be disposed on the filtering flow path 90, and particularly, disposed inside the dispenser body 510 to heat the water passing through the dispensing flow path 90a among the filtering flow path 90. Alternatively, the heater 100 may be disposed upstream from the dispensing flow path 90a. Alternatively, the heater 100 may be disposed upstream from the filtering flow path 90. The heater 100 may be arranged upstream from the filter (F) to directly heat raw water.

As mentioned above, the water purifier 2 may include the heater 100 so as to provide heated purified water.

The water purifier 2 may include a controller 50B configured to control various configurations of the water purifier 2.

The controller 50B may include a processor 51B configured to generate a control signal related to the operation of the water purifier 2, and memory 52B configured to store programs, applications, instructions, and/or data for the operation of the water purifier 2. The processor 51B and the memory 52B may be implemented as separate semiconductor devices or as a single semiconductor device.

Further, the controller 50B may include a plurality of processors or a plurality of memories. The controller 50B may be disposed at various locations inside the water purifier 2.

The processor 51B may include an arithmetic circuit, memory circuit, and a control circuit. The processor 51B may include one chip or a plurality of chips. Additionally, the processor 51B may include one core or a plurality of cores.

The memory 52B may store various programs and data required for control, and temporarily store temporary data generated during control.

The memory 52B may include volatile memory such as Static Random Access Memory (S-RAM) and Dynamic Random Access Memory (D-RAM), and non-volatile memory such as Read Only Memory (ROM) and Erasable Programmable Read Only Memory (EPROM). The memory 52B may include one memory element or may include a plurality of memory elements.

The processor 51B may be electrically connected to the memory 52B. The processor 51B may process data and/or signals using a program provided from the memory 52B, and may transmit control signals to each configuration of the water purifier 2 based on the processing results. Each configuration of the water purifier 2 may be operated based on a control signal from the processor 51B.

For example, electronic components constituting the controller 50B may be disposed inside the dispenser body 510. Alternatively, the controller 50B may be disposed inside the filtering body 10B. Further, the controller 50B may be composed of a plurality of modules, and some of the plurality of modules may be disposed inside the dispenser body 510, and other modules may be disposed inside the filtering body 10B. However, the disclosure is not limited thereto, and the electronic components constituting the controller 50B may be disposed at various locations in the water purifier 2.

The user interface 550 of the water purifier 2 may include an input device 551 for receiving a user input. Types of user input that are received through the input device 551 may include on/off setting of power of the water purifier 2, setting a dispensed water volume, and setting a temperature of purified water (that is, a degree of heat generation of the heater 100).

For example, the input device 551 may include a room temperature water button configured to obtain a user input that sets the discharge of room temperature purified water through the dispenser 500, a hot water button configured to obtain a user input that sets the discharge of hot water through the dispenser 500, a cold water button configured to obtain a user input that sets the discharge of cold water through the dispenser 500, a dispensed water volume setting button configured to obtain a user input that sets a target amount of liquid discharged through the dispenser 500, or a dispensing button configured to obtain a user input that requests to dispense purified water of a set temperature through the dispenser 500. According to the configuration of the water purifier 2, the input device 551 may include buttons configured to obtain a user input requesting to discharge various types of liquid, as well as purified water.

The input device 551 may include various types of input devices such as a tact switch, a push switch, a slide switch, a toggle switch, a micro switch, or a touch switch.

The input device 551 may be electrically connected to the controller 50B. The input device 551 may receive a user input, output an electrical signal (voltage or current) corresponding to the user input, and transmit the electrical signal to the controller 50B. The controller 50B may receive a user input based on the output signal of the input device 551.

The user interface 550 may include a display 552 for displaying information related to the operation or status of the water purifier 2.

The information related to the operation or status of the water purifier 2 displayed on the display 552 may include setting information corresponding to the user input (dispensed water volume setting/temperature setting, and the like), and operation information of the water purifier 2.

The display 552 may be electrically connected to the controller 50B. The display 552 may display setting information corresponding to a user input and/or operation information of the water purifier 2 based on the signal received from the controller 50B.

For example, the display 552 may include a liquid crystal display (LCD) panel, and a light emitting diode (LED) panel.

However, the configuration of the user interface 550 provided in the water purifier 2 according to the disclosure is not limited thereto, and various types of user interfaces may be provided.

As described above, the water purifier 2 may include the dispensing lever 530. The dispensing lever 530 may be configured to change a position or posture thereof by a physical pressure from a user. The dispensing lever 530 may include a dispensing switch 531 configured to be turned on or off (closed or open) according to the position or posture of the dispensing lever 530. For example, when the dispensing lever 530 is in a first position or a first posture, the dispensing switch 531 may be turned off (or open). When the dispensing lever 530 is moved to a second position or a second posture by a user's physical pressure, the dispensing switch 531 may be turned on (or closed).

The dispensing switch 531 may obtain a user input for requesting to dispense a liquid (for example, purified water) through the dispenser 500. The dispensing switch 531 may include a push switch, a micro switch, or a reed switch.

The dispensing switch 531 may output an electrical signal corresponding to the obtained user input and provide the electrical signal to the controller 50B. The controller 50B may identify a user input for requesting to dispense a liquid based on the output signal of the dispensing switch 531. The controller 50B may control the valve device 540 to open the dispensing flow path 90a based on the output signal of the dispensing switch 531.

Based on the above description, the dispensing lever 530 may be considered as a type of input device.

As described above, the water purifier 2 may include the valve device 540 configured to open or close the flow path. When the valve device 540 opens the flow path, water may flow along the open flow path. When the valve device 540 closes the flow path, water may not flow along the flow path. For example, the valve device 540 may be configured to open and close the dispensing flow path 90a.

At this time, the controller 50B may control the valve device 540. The controller 50B may be electrically connected to the valve device 540, and the valve device 540 may open or close the flow path based on a control command received from the controller 50B. For example, the controller 50B may control the operation of the valve device 540 based on a user input obtained from the input device 551 or the dispensing lever 530.

The valve device 540 may include an electric operated valve (solenoid valve, and the like) configured to open and close the flow path by a driving current (or driving voltage).

As described above, the water purifier 2 may include the cooling device 60. The cooling device 60 may be configured to cool a liquid. For example, the cooling device 60 may be configured to cool purified water. Further, the cooling device 60 may be configured to cool raw water.

As described above, the cooling device 60 may include the cooling circuit. At this time, the compressor constituting the cooling circuit of the cooling device 60 may include a motor. The compressor of the cooling device 60 may circulate a refrigerant in the cooling circuit using a torque of the motor. The cooling device 60 may cool a liquid by the evaporation of the refrigerant circulating in a refrigerant circuit.

The controller 50B may control the cooling device 60. The controller 50B may be electrically connected to the cooling device 60. The controller 50B may control the cooling device 60 to cool water based on a condition for providing cold water. For example, the controller 50B may control the cooling device 60 to cool the liquid by applying a driving current to the motor of the compressor of the cooling device 60.

The controller 50B may be electrically connected to the power supplier 40 of the heater 100. The controller 50B may control the power supplier 40 to apply or not apply a voltage between the plurality of electrodes 300 based on a predetermined condition.

The predetermined condition may include a user input that is obtained through the input device 551 or the dispensing lever 530. For example, when a user input for discharging hot water is obtained through the input device 551 or the dispensing lever 530, the controller 50B may control the power supplier 40 to allow a voltage to be applied between the plurality of electrodes 300 so as to allow the heater 100 to heat water at a temperature in a predetermined range. For example, when a user input for discharging warm water, room temperature water or cold water is obtained through the input device 551 or the dispensing lever 530, the controller 50B may control the power supplier 40 to allow a voltage not to be applied between the plurality of electrodes 300 or to allow a magnitude of the applied voltage to be reduced.

For example, electronic components constituting the power supplier 40 may be disposed inside the dispenser body 510. However, the disclosure is not limited thereto, and the electronic components constituting the power supplier 40 may be disposed at various locations in the water purifier 2. For example, the electronic components constituting the power supplier 40 may be disposed in the filtering body 10B or may be disposed in a configuration other than the dispenser 500 or the filtering body 10B.

FIG. 22 is a cross-sectional view illustrating a portion of a water purifier according to an embodiment of the disclosure.

Referring to FIG. 22, a heater 100-2 of a water purifier 2 according to an embodiment of the disclosure may include an inlet 101-2 through which a liquid (for example, purified water) flows into the heater 100-2 and an outlet 102-2 through which a liquid is discharged from the heater 100-2. A heating flow path 103-2 through which a liquid is heated may be formed between the inlet 101-1 and the outlet 102-2. A liquid may flow along the heating flow path 103-2.

The heater 100-2 may include at least one graphene scroll 200-2. The heating flow path 103-2 may be formed by the at least one graphene scroll 200-2. The at least one graphene scroll 200-2 may be configured to heat the liquid flowing along the heating flow path 103-2. The at least one graphene scroll 200-2 may be configured to generate heat based on a voltage being applied.

Referring to FIG. 22, a width r2 of the outlet 102-2 of the heater 100-2 may be less than a width r1 of the inlet 101-2. In other words, a cross-sectional area of the outlet 102-1 may be less than a cross-sectional area of the inlet 101-1.

Accordingly, a cross-sectional area of one side of the heating flow path 103-2 adjacent to the outlet 102-2 may be less than a cross-sectional area of the other side of the heating flow path 103-2 adjacent to the inlet 101-2. As illustrated in FIG. 22, the heating flow path 103-2 may be formed to have a width that is reduced from the inlet 101-2 toward the outlet 102-2.

Referring to FIG. 22, a width of the heating flow path 103-2 may decrease at a constant rate from the inlet 101-2 toward the outlet 102-2, but is not limited thereto.

In other words, the graphene scroll 200-2 may be formed to allow a cross-sectional area of the heating flow path 103-2 on a side adjacent to the outlet 102-2 to be less than a cross-sectional area of the heating flow path 103-2 on a side adjacent to the inlet 101-2.

The width of the heating flow path 103-2, the width r1 of the inlet 101-2, and the width r2 of the outlet 102-2 refer to a width measured in a direction perpendicular to a central axis (CA) of the heating flow path 103-2.

In addition, the cross-sectional area of the heating flow path 103-2, the cross-sectional area of the inlet 101-2, and the cross-sectional area of the outlet 102-2 refer to an area of a cross section that is cut into a plane perpendicular to the central axis (CA) of the heating flow path 103-2.

With this configuration, a flow rate of the liquid flowing in through the outlet 102-2 may be greater than a flow rate of the liquid flowing in through the inlet 101-2, and thus the water purifier 2 may provide purified water at a faster rate.

The configuration of the heater 100 or 100-2 including the graphene scroll 200 or 200-2 and the electrode 300, which is included in the water purifier according to the embodiment of FIGS. 18 to 22 may correspond to the heater 100 or 100-2 applied to the hot air blower 1 described with reference to FIGS. 3 to 17, and thus a detailed description thereof will be omitted.

In the above, the configuration of the water purifier including the heater is described with reference to FIGS. 18 to 22. However, the above-described configuration may be applied to various devices (for example, humidifiers, steam ovens, dishwashers, steam cleaners, and clothes care apparatuses) that are configured to heat water using the heater.

In addition, the configuration described above may be applied to various types of dispensing devices configured to heat not only water but also beverages such as coffee and milk and other liquids using the heater, and configured to provide the heated water, beverages and other liquids.

The configuration described above may be applied to various types of devices including heaters that are configured to heat fluids having various phases, including gases and liquids.

A heater according to an embodiment of the disclosure may be configured to heat a fluid. The heater may include a first graphene scroll configured to generate heat in response to a current flowing, a first electrode configured to apply a voltage to the first graphene scroll, a second graphene scroll disposed in parallel to the first graphene scroll, forming a heating flow path, in which a fluid is heated, together with the first graphene scroll, and configured to generate heat in response to a current flowing, and a second electrode configured to apply a voltage to the second graphene scroll.

The first graphene scroll and the second graphene scroll may be spaced apart from each other. The heating flow path may be formed in a separation space between the first graphene scroll and the second graphene scroll.

The heater may further include a spacer disposed between the first graphene scroll and the second graphene scroll to maintain the separation space between the first graphene scroll and the second graphene scroll.

At least a portion of the first graphene scroll may cover at least a portion of the second graphene scroll from an outer direction. At least a portion of the second graphene scroll may cover at least a portion of the first graphene scroll from an outer direction.

The first electrode may include a pair of first electrodes connected to the first graphene scroll. The second electrode may include a pair of second electrodes connected to the second graphene scroll.

The heater may further include at least one power supplier. The at least one power supplier may be configured to apply a voltage between the pair of first electrodes or apply a voltage between the pair of second electrodes.

The at least one power supplier may be configured to apply a voltage between the pair of first electrodes or apply a voltage between the pair of second electrodes based on a condition for heating a fluid at a first temperature. The at least one power supplier may be configured to apply a voltage between the pair of first electrodes and apply a voltage between the pair of second electrodes based on a condition for heating a fluid at a second temperature higher than the first temperature.

The at least one power supplier may be configured to apply a voltage between the pair of first electrodes based on a condition for heating a fluid at a first temperature. The at least one power supplier may be configured to apply a voltage between the pair of second electrodes based on a condition for heating a fluid at a second temperature higher than the first temperature. The at least one power supplier may be configured to apply a voltage between the pair of first electrodes and apply a voltage between the pair of second electrodes based on a condition for heating a fluid at a third temperature higher than the second temperature.

The heating flow path may extend between an inlet, through which a fluid flows into the heater, and an outlet, through which a fluid is discharged from the heater. The first graphene scroll and the second graphene scroll may extend between the inlet and the outlet along the heating flow path, respectively.

A distance, in which the first graphene scroll extends between the inlet and the outlet, and a distance, in which the second graphene scroll extends between the inlet and the outlet, may be the same.

The first graphene scroll may extend to allow a distance, which is from a central axis of the heating flow path extending between the inlet and the outlet, to increase from one end adjacent to the central axis of the heating flow path toward another end. The second graphene scroll may extend to allow a distance, which is from a central axis of the heating flow path extending between the inlet and the outlet, to increase from one end adjacent to the central axis of the heating flow path toward another end.

The first graphene scroll may extend in a first direction from the one end adjacent to the central axis of the heating flow path toward the another end. The second graphene scroll may extend in the first direction from the one end adjacent to the central axis of the heating flow path toward the another end.

A length, in which the first graphene scroll extends from the one end adjacent to the central axis of the heating flow path to the another end, and a length, in which the second graphene scroll extends from the one end adjacent to the central axis of the heating flow path to the another end, may be the same.

The first electrode may extend in a direction parallel to the direction in which the first graphene scroll extends from the one end adjacent to the central axis of the heating flow path toward the another end. The second electrode may extend in a direction parallel to the direction in which the second graphene scroll extends from the one end adjacent to the central axis of the heating flow path toward the another end.

The first electrode and the second electrode each may extend in a direction parallel to a direction in which the heating flow path extends from the inlet toward the outlet.

A hot air blower according to an embodiment of the disclosure may include a main body, a fan disposed in the main body, and a heater disposed in the main body and configured to heat air flowing along a heating flow path as the fan rotates. The heater may include a first graphene scroll configured to generate heat in response to a current flowing, a first electrode configured to apply a voltage to the first graphene scroll, a second graphene scroll disposed in parallel to the first graphene scroll, forming the heating flow path together with the first graphene scroll, and configured to generate heat in response to a current flowing, and a second electrode configured to apply a voltage to the second graphene scroll.

The first graphene scroll and the second graphene scroll may be arranged to overlap each other at a position spaced apart from each other. The heating flow path may be formed in a separation space between the first graphene scroll and the second graphene scroll.

The graphene scroll may be formed to allow a cross-sectional area of the heating flow path on a side through which air is introduced into the heating flow path, to be larger than a cross-sectional area of the heating flow path on a side through which air is discharged from the heating flow path.

A water purifier according to an embodiment of the disclosure may include a dispenser configured to provide purified water and a heater configured to heat the purified water flowing along a heating flow path. The heater may include a first graphene scroll configured to generate heat in response to a current flowing, a first electrode configured to apply a voltage to the first graphene scroll, a second graphene scroll disposed in parallel to the first graphene scroll, forming a heating flow path, in which a fluid is heated, together with the first graphene scroll, and configured to generate heat in response to a current flowing, and a second electrode configured to apply a voltage to the second graphene scroll.

The dispenser may further include a nozzle through which purified water is discharged. The heater may be detachably mounted to the nozzle.

Meanwhile, the control method of the hot air blower may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored. For example, there may be a Read Only Memory (ROM), a Random Access Memory (RAM), a magnetic tape, a magnetic disk, a flash memory, and an optical data storage device.

Storage medium readable by machine may be provided in the form of a non-transitory storage medium. “Non-transitory” means that the storage medium is a tangible device and does not contain a signal (e.g., electromagnetic wave), and this term includes a case in which data is semi-permanently stored in a storage medium and a case in which data is temporarily stored in a storage medium. For example, a “non-transitory storage medium” may include a buffer in which data is temporarily stored.

The method according to the various disclosed embodiments may be provided by being included in a computer program product. Computer program products may be traded between sellers and buyers as commodities. Computer program products are distributed in the form of a device-readable storage medium (e.g., compact disc read only memory (CD-ROM)), or are distributed directly or online (e.g., downloaded or uploaded) between two user devices (e.g., smartphones) through an application store (e.g., Play Store™). In the case of online distribution, at least a portion of the computer program product (e.g., downloadable app) may be temporarily stored or created temporarily in a device-readable storage medium such as the manufacturer's server, the application store's server, or the relay server's memory.

As is apparent from the above description, a heater may use a graphene heating element having the high heating efficiency, as a heat source, and thus the heating efficiency of the fluid may be improved.

Further, a heater may use a graphene heating element having the high heating efficiency, as a heat source, and thus power consumption of the heater may be reduced.

Further, a heater may use a graphene heating element, which is heated at a rapid rate when a voltage is applied and quickly restored to an original temperature when a voltage is stopped, as a heat source, and thus a temperature change speed of the heater may be improved.

Further, a heater may include a graphene scroll having a shape in which a graphene sheet is rolled into a scroll shape, thereby increasing a heating area and improving the heating efficiency of a fluid.

Further, a heater may include a spacer so as to prevent a shape of a graphene scroll from being deformed.

Further, a heater may include an electrode electrically connected to a graphene scroll to apply a voltage, thereby facilitating the heat generation control.

Further, a plurality of graphene scrolls may be included in a single heater, thereby improving the heating efficiency of a fluid.

Further, a plurality of graphene scrolls may be included in a single heater, and the plurality of graphene scrolls may be independently supplied with a voltage through electrodes connected thereto, thereby facilitating the heat generation control of the heater.

Further, a heater may have a cross-sectional area of an outlet smaller than a cross-sectional area of an inlet, and thus a speed of hot air discharged through the outlet may increase.

Additional aspects of the disclosure will be set forth in part in the description which follows and, in part, will be obvious from the description, or may be learned by practice of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A heater configured to heat a fluid comprising:
a first graphene scroll configured to generate heat in response to a current flowing;
a first electrode configured to apply a first voltage to the first graphene scroll;
a second graphene scroll disposed in parallel to the first graphene scroll, forming a heating flow path, in which a fluid is heated, together with the first graphene scroll, and configured to generate heat in response to the current flowing; and
a second electrode configured to apply a second voltage to the second graphene scroll.

2. The heater of claim 1,
wherein the first graphene scroll and the second graphene scroll are spaced apart from each other, and
wherein the heating flow path is formed in a separation space between the first graphene scroll and the second graphene scroll.

3. The heater of claim 2, further comprising:
a spacer disposed between the first graphene scroll and the second graphene scroll to maintain the separation space between the first graphene scroll and the second graphene scroll.

4. The heater of claim 1,
wherein at least a portion of the first graphene scroll covers at least a portion of the second graphene scroll from an outer direction, and
wherein at least a portion of the second graphene scroll covers at least a portion of the first graphene scroll from an outer direction.

5. The heater of claim 1,
wherein the first electrode comprises a pair of first electrodes connected to the first graphene scroll, and
wherein the second electrode comprises a pair of second electrodes connected to the second graphene scroll.

6. The heater of claim 5, further comprising:
at least one power supplier,
wherein the at least one power supplier is configured to apply a voltage between the pair of first electrodes or apply a voltage between the pair of second electrodes.

7. The heater of claim 6, wherein the at least one power supplier is further configured to:
apply a voltage between the pair of first electrodes or apply a voltage between the pair of second electrodes based on a condition for heating a fluid at a first temperature; and
apply a voltage between the pair of first electrodes and apply a voltage between the pair of second electrodes based on a condition for heating a fluid at a second temperature higher than the first temperature.

8. The heater of claim 6, wherein the at least one power supplier is further configured to:
apply a voltage between the pair of first electrodes based on a condition for heating a fluid at a first temperature;
apply a voltage between the pair of second electrodes based on a condition for heating a fluid at a second temperature higher than the first temperature; and
apply a voltage between the pair of first electrodes and apply a voltage between the pair of second electrodes based on a condition for heating a fluid at a third temperature higher than the second temperature.

9. The heater of claim 1,
wherein the heating flow path extends between an inlet, through which a fluid flows into the heater, and an outlet, through which a fluid is discharged from the heater, and
wherein the first graphene scroll and the second graphene scroll extend between the inlet and the outlet along the heating flow path, respectively.

10. The heater of claim 9, wherein a first distance, in which the first graphene scroll extends between the inlet and the outlet, and a second distance, in which the second graphene scroll extends between the inlet and the outlet, are the same.

11. The heater of claim 9,
wherein the first graphene scroll extends to allow a first distance, which is from a central axis of the heating flow path extending between the inlet and the outlet, to increase from one end adjacent to the central axis of the heating flow path toward another end, and
wherein the second graphene scroll extends to allow a second distance, which is from a central axis of the heating flow path extending between the inlet and the outlet, to increase from one end adjacent to the central axis of the heating flow path toward another end.

12. The heater of claim 11,
wherein the first graphene scroll extends in a first direction from the one end adjacent to the central axis of the heating flow path toward the another end, and
wherein the second graphene scroll extends in the first direction from the one end adjacent to the central axis of the heating flow path toward the another end.

13. The heater of claim 12, wherein a first length, in which the first graphene scroll extends from the one end adjacent to the central axis of the heating flow path to the another end, and a second length, in which the second graphene scroll extends from the one end adjacent to the central axis of the heating flow path to the another end, are the same.

14. The heater of claim 11,
wherein the first electrode extends in a direction parallel to the direction in which the first graphene scroll extends from the one end adjacent to the central axis of the heating flow path toward the another end, and
wherein the second electrode extends in a direction parallel to the direction in which the second graphene scroll extends from the one end adjacent to the central axis of the heating flow path toward the another end.

15. The heater of claim 9, wherein the first electrode and the second electrode each extend in a direction parallel to a direction in which the heating flow path extends from the inlet toward the outlet.
